(19) United States
(12) Patent Application Publication
(10) Pub. No.: US 2025/0338281 A1
(43) Pub. Date: Oct. 30, 2025

(54) METHOD AND APPARATUS FOR A LINK ADAPTATION IN NTN COMMUNICATION SYSTEM

(71) Applicant: SAMSUNG ELECTRONICS CO., LTD., Suwon-si (KR)

(72) Inventors: Zhengsen YANG, Beijing (CN); Junwei REN, Beijing (CN); Dongzhi ZHU, Beijing (CN); Congying JIANG, Beijing (CN); Zhigang WANG, Beijing (CN); Sitong WANG, Beijing (CN); Nan CAO, Beijing (CN)

(21) Appl. No.: 19/191,455

(22) Filed: Apr. 28, 2025

(30) Foreign Application Priority Data
Apr. 28, 2024 (CN) 202410528797.6

(51) Int. Cl. H04W 72/23; H04B 17/309; H04L 5/00

(52) U.S. Cl. CPC H04W 72/23; H04B 17/346; H04L 5/0055

(57) ABSTRACT

The disclosure relates to a 5G or 6G communication system for supporting higher data rates. The disclosure provides a method performed by a base station of an NTN. The method includes: transmitting, to a terminal, a first PDSCH in first slots, wherein the first slots include at least one slot where the first PDSCH is scheduled without HARQ feedback; receiving, from the terminal, channel quality information and feedback information, wherein the feedback information includes HARQ feedback information and RLC status information associated with a transmission of the first PDSCH in the at least one slot; predicting a MCS and a repetition number for a second PDSCH, based on the information associated with the channel quality information and the feedback information; transmitting, to the terminal, information on the MCS and information on the repetition number; and transmitting, to the terminal, the second PDSCH in second slots.

### CROSS-REFERENCE TO RELATED APPLICATION

This application is based on and claims priority under 35 U.S.C. § 119 to Chinese Patent Application No. 202410528797.6, filed on Apr. 28, 2024, in the Chinese Intellectual Property Office, the disclosure of which is incorporated by reference herein in its entirety.

### BACKGROUND

### 1. Field

The disclosure relates to operations of a terminal and a base station in a wireless communication system. In particular, the disclosure relates to a method and an apparatus for a link adaptation in a non-terrestrial network (NTN) communication system.

### 2. Description of Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive plurality of input plurality of output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In 6G NTN (Non-Terrestrial Network) system, the number of satellites increases and the satellite altitudes become more diverse compared to 5G NTN. In the case of direct communication between a terminal and a satellite, there is a significant difference in terminal performance, such as throughput, depending on whether the communication link is in a line-of-sight (LOS) or non-line-of-sight (NLOS) condition. When the satellite used for NTN is a low earth orbit (LEO) satellite, the communication condition frequently changes between LOS and NLOS due to the fast orbital speed of the satellite. On the other hand, in the case of a geostationary earth orbit (GEO) satellite, the round-trip time (RTT) becomes longer.

Due to these characteristics of NTN communication, if various techniques used in terrestrial communication (e.g., link adaptation) are applied as they are, there may be a delay in signal transmission and reception delays, and the quality of communication may deteriorate due to the inability to reflect real-time channel conditions.

Accordingly, discussions are ongoing to enable the satellite to provide more accurate information to the terminal, so that the terminal can perform communication with the satellite more effectively based on the provided information.

### SUMMARY

The disclosure relates to operations of a terminal and a base station in a wireless communication system. In particular, the disclosure relates to a method and an apparatus for a link adaptation in a non-terrestrial network (NTN) communication system.

Accordingly, an aspect of the disclosure is to provide a method and an apparatus for determining an optimal MCS and REP of downlink channels for enhancing link adaptation.

In addition, an aspect of the disclosure is to provide a method and an apparatus for determining the optimal MCS and REP, regardless of whether a HARQ process is enabled, by utilizing HARQ ACK/NACK feedback and/or RLC status PDU feedback, along with CQI.

Furthermore, an aspect of the disclosure is to provide a method and an apparatus for enabling enhanced link adaptation by selecting an appropriate AI-based prediction model that uses CQI, SINR, BLER, and/or MCS/REP information as input data.

Additional aspects will be set forth in part in the description which follows and, in part, will be apparent from the description, or may be learned by practice of the presented embodiments.

Aspects of the disclosure are to address at least the above-mentioned problems and/or disadvantages and to provide at least the advantages described below.

According to an aspect of an embodiment of the disclosure, a method performed by a base station of an NTN in a wireless communication system is provided. The method includes transmitting, to a terminal, a first physical downlink shared channel (PDSCH) in first slots, wherein the first slots include at least one slot where the first PDSCH is scheduled without hybrid automatic repeat request (HARQ) feedback; receiving, from the terminal, channel quality information and feedback information, wherein the feedback information includes HARQ feedback information and radio link control (RLC) status information associated with a transmission of the first PDSCH in the at least one slot; predicting a modulation and coding scheme (MCS) and a repetition number for a second PDSCH, based on the information associated with the channel quality information and the feedback information; transmitting, to the terminal, information on the MCS and information on the repetition number; and transmitting, to the terminal, the second PDSCH in second slots, using the MCS and the repetition number.

According to an aspect of an embodiment of the disclosure, a method performed by a terminal in a wireless communication system is provided. The method includes receiving, from a base station of a non-terrestrial network (NTN), a first physical downlink shared channel (PDSCH) in first slots, wherein the first slots include at least one slot where the first PDSCH is scheduled without a hybrid automatic repeat request (HARQ) feedback; generating channel quality information, HARQ feedback information, and radio link control (RLC) status information associated with a reception of the first PDSCH in the at least one slot, based on the reception of the first PDSCH; transmitting, to the base station, the channel quality information and feedback information including the HARQ feedback information and the RLC status information; receiving, from the base station, information on a modulation and coding scheme (MCS) for a second PDSCH and information on a repetition number for the second PDSCH, and receiving, from the base station, the second PDSCH in second slots, using the MCS and the received repetition number.

According to an aspect of an embodiment of the disclosure, a base station of an NTN in a wireless communication system is provided. The base station includes a transceiver; memory storing one or more computer programs; and one or more processors communicatively coupled to the transceiver and the memory, wherein the one or more programs include computer-executable instructions that, when executed by the one or more processors individually or collectively, cause the base station to: transmit, to a terminal, a first physical downlink shared channel (PDSCH) in first slots, wherein the first slots include at least one slot where the first PDSCH is scheduled without hybrid automatic repeat request (HARQ) feedback, receive, from the terminal, channel quality information and feedback information, wherein the feedback information includes HARQ feedback information and radio link control (RLC) status information associated with a transmission of the first PDSCH in the at least one slot, predict a modulation and coding scheme (MCS) and a repetition number for the second PDSCH, based on the information associated with the channel quality information and the feedback information, transmit, to the terminal, information on the MCS and information on the repetition number, and transmit, to the terminal, the second PDSCH in second slots, using the MCS and the repetition number.

According to an aspect of an embodiment of the disclosure, a terminal in a wireless communication system is provided. The terminal includes a transceiver; memory storing one or more computer programs; and one or more processors communicatively coupled to the transceiver and the memory, wherein the one or more programs include computer-executable instructions that, when executed by the one or more processors individually or collectively, cause the terminal to: receive, from a base station of a non-terrestrial network (NTN), a first physical downlink shared channel (PDSCH) in first slots, wherein the first slots include at least one slot where the first PDSCH is scheduled without a hybrid automatic repeat request (HARQ) feedback, generate channel quality information, HARQ feedback information, and radio link control (RLC) status information associated with a reception of the first PDSCH in the at least one slot, based on the reception of the first PDSCH, transmit, to the base station, the channel quality information and feedback information including the HARQ feedback information and the RLC status information, receive, from the base station, information on a modulation and coding scheme (MCS) for a second PDSCH and information on a repetition number for the second PDSCH, and receive, from the base station, the second PDSCH in second slots, using the MCS and the repetition number.

According to an aspect of an embodiment of the disclosure, a method performed by a first network node is provided, which includes: obtaining channel-related information of physical downlink shared channel (PDSCH) transmission within a first time unit; predicting information related to modulation and coding scheme (MCS) and/or repetition number (REP) for PDSCH transmission, based on the channel-related information, through an AI network; transmitting the predicted information related to MCS and/or REP to a user equipment; wherein the channel-related information comprises at least one of channel quality indicator (CQI) information, block error rate (BLER) information, signal to interference plus noise ratio (SINR) information, MCS information and REP information; the BLER information is obtained based on hybrid automatic repeat request (HARQ) ACK/NACK information for the PDSCH transmission, and at least part of the HARQ ACK/NACK information for the PDSCH transmission is obtained based on a radio link control (RLC) status protocol data unit (PDU).

Alternatively, in a case that the HARQ ACK/NACK information for the PDSCH transmission comprises HARQ ACK/NACK feedback received from the user equipment, if the PDSCH transmission for the received HARQ ACK/NACK feedback is the first transmission, the received HARQ ACK/NACK feedback is determined as the HARQ ACK/NACK information for the PDSCH transmission; or if the PDSCH transmission for the received HARQ ACK/NACK feedback is not the first transmission and the received HARQ ACK/NACK feedback is NACK, the received HARQ ACK/NACK feedback is determined as the HARQ ACK/NACK information for the PDSCH transmission; or if the PDSCH transmission for the received HARQ ACK/NACK feedback is not the first transmission and the received HARQ ACK/NACK feedback is ACK, the HARQ ACK/NACK information for the PDSCH transmission is determined, according to the number of transmission of the PDSCH transmission and channel information related to the PDSCH transmission.

Alternatively, in a case that the HARQ ACK/NACK information for the PDSCH transmission comprises HARQ ACK/NACK feedback received from the user equipment, if the PDSCH transmission for the received HARQ ACK/NACK feedback is the first transmission, the received HARQ ACK/NACK feedback is determined as the HARQ ACK/NACK information for the PDSCH transmission; if the PDSCH transmission for the received HARQ ACK/NACK feedback is not the first transmission, the HARQ ACK/NACK information for the PDSCH transmission is determined, according to the number of transmissions of the PDSCH transmission and channel information related to the PDSCH transmission.

Alternatively, the determining the HARQ ACK/NACK information for the PDSCH transmission according to the number of transmission of the PDSCH transmission and channel information related to the PDSCH transmission comprises: determining a probability that the HARQ feedback for the first transmission of the PDSCH transmission is NACK, according to the number of transmissions of the PDSCH transmission and the channel information related to the PDSCH transmission, if the probability is greater than or equal to a threshold, determining the HARQ ACK/NACK information for the PDSCH transmission as NACK; or if the probability is less than the threshold, determining the HARQ ACK/NACK information for the PDSCH transmission as ACK.

Alternatively, the channel information related to the PDSCH transmission comprises at least one of an initial transmission rate of the PDSCH transmission, and channel quality of the PDSCH transmission.

Alternatively, the at least part of the HARQ ACK/NACK information for the PDSCH transmission is obtained by: determining ACK/NACK feedback corresponding to a sequence number (SN) of each RLC PDU contained in the RLC status PDU, according to the RLC status PDU; determining the HARQ ACK/NACK information for the PDSCH transmission, according to correspondence relationship between a SN of a PDU and a time unit associated with the PDU, and the ACK/NACK feedback corresponding to the SN, wherein the correspondence relationship is determined based on a RLC data PDU and scheduling information of the PDSCH transmission.

Alternatively, when there are segments in the RLC status PDU, the corresponding relationship is also based on a segmentation offset (SO) of the RLC status PDU.

Alternatively, the obtaining of the BLER information in the channel-related information based on hybrid automatic repeat request (HARQ) ACK/NACK information for the PDSCH transmission comprises: by filtering the HARQ ACK/NACK information for the PDSCH transmission according to a specified window length, obtaining the BLER information in the channel-related information.

Alternatively, the SINR information is obtained by: determining path loss between the network node and the user equipment, according to weather information and/or ephemeris information of a satellite associated with the network node; determining the SINR information in the channel-related information, according to the path loss and a transmission power for the network node.

Alternatively, the determining the path loss between the network node and the user equipment, according to the weather information and/or the ephemeris information of the satellite associated with the network node comprises: determining first path loss between the network node and the user equipment, according to the ephemeris information; determining at least one of a first loss correction value related to air density, a second loss correction value related to atmospheric pressure, and a third loss correction value related to air humidity, according to the weather information; determining second path loss between the network node and the user equipment, according to the first path loss and at least one of the first loss correction value, the second loss correction value and the third loss correction value.

Alternatively, the determining the first loss correction value related to air density according to the weather information comprises: determining the first loss correction value, according to zenith attenuation and a satellite elevation angle between the user equipment and the satellite.

Alternatively, the determining the SINR information comprises: correcting the estimated signal received power and signal noise according to a reference signal received power (RSRP) and SINR received from the user equipment; determining the SINR information, based on the corrected signal received power and the corrected signal noise.

According to a second aspect of an embodiment of the disclosure, a method performed by a network node is provided, which includes: obtaining channel-related information of physical downlink shared channel (PDSCH) within a first time unit; predicting information related to modulation and coding scheme (MCS) and/or repetition number (REP) for PDSCH, based on the channel-related information, through an AI network; transmitting the predicted information related to MCS and/or REP to a user equipment; wherein the predicting the information related to MCS and/or REP for PDSCH, based on the channel-related information, through the AI network comprises: obtaining a first channel feature, based on MCS and/or REP which is obtained by a previous prediction, and the channel-related information; obtaining a second channel feature, based on the channel-related information; predicting the information related to MCS and/or REP for PDSCH, based on the first channel feature and the second channel feature.

Alternatively, the channel-related information comprises MCS and/or REP of PDSCH transmission within the first time unit, channel quality indicator (CQI) information, block error rate (BLER) information, and signal to interference plus noise ratio (SINR) information.

Alternatively, the determining basic path loss between the network node and the user equipment according to the ephemeris information includes: determining free-space path loss between the network node and the user equipment according to the ephemeris information; determining shadow attenuation and clutter loss; determining the basic path loss between the network node and the user equipment according to the free-space path loss, the shadow attenuation and the clutter loss.

Alternatively, the determining the free-space path loss between the network node and the user equipment according to the ephemeris information includes: determining a position of a satellite related to the network node according to the ephemeris information; determining a distance between the satellite and the user equipment according to the position of the satellite; determining the free-space path loss between the network node and the user equipment according to the distance.

Alternatively, the determining the SINR information in the channel-related information, according to the path loss and a transmission power for the network node includes: estimating a signal received power of the user equipment according to the path loss and the transmission power for the network node; determining the SINR information according to the estimated signal received power and signal noise.

Alternatively, the determining the SINR information includes: correcting the estimated signal received power and signal noise according to a reference signal received power (RSRP) and SINR received from the user equipment; determining the SINR information, based on the corrected signal received power and the corrected signal noise.

Alternatively, the determining the SINR information according to the estimated signal received power of the user equipment and signal noise further includes: performing filtering on a plurality of pieces of the corrected SINR information to determine the SINR information.

Alternatively, the obtaining the first channel feature, based on the MCS and/or REP which is obtained by the previous prediction, and the channel-related information comprises: obtaining a first feature vector based on the MCS and/or REP which is obtained by the previous prediction and the channel-related information, through a first sigmoid neural network layer in the AI network; obtaining a second feature vector based on the MCS and/or REP which is obtained by the previous prediction and the channel-related information, through a first tanh neural network layer in the AI network; obtaining a third feature vector by transforming the first feature vector; obtaining the first channel feature, based on the first feature vector, the second feature vector and the third feature vector.

Alternatively, the obtaining the second channel feature, based on the channel-related information comprises: obtaining a fourth feature vector based on the channel-related information, through a second sigmoid neural network layer in the AI network; obtaining a fifth feature vector based on the channel-related information, through a second tanh neural network layer in the AI network; obtaining the second channel feature based on the fourth feature vector and the fifth feature vector.

Alternatively, the predicting the information related to MCS and/or REP for PDSCH, based on the first channel feature and the second channel feature comprises: obtaining a third channel feature by fusing the first channel feature and the second channel feature; predicting the information related to MCS and/or REP for PDSCH based on the third channel feature.

Alternatively, the predicting the information related to MCS and/or REP for PDSCH based on the third channel feature comprises: obtaining a sixth feature vector based on the MCS and/or REP which is obtained by the previous prediction and the channel-related information, through a third sigmoid neural network layer in the AI network; obtaining a seventh feature vector based on the third channel feature, through a third tanh neural network layer in the AI network; obtaining the information related to MCS and/or REP for PDSCH, by processing the sixth feature vector and the seventh feature vector.

Alternatively, the BLER is obtained based on the process for obtaining the BLER as described above.

According to a third aspect of an embodiment of the disclosure, a method performed by a network node is provided, which including: transmitting predicted information related to repetition number (REP) to a user equipment, through one of a first media access control (MAC) control element (CE) and a second MAC CE; and transmitting predicted information related to modulation and coding scheme (MCS) to the user equipment, through a downlink control indicator (DCI).

Alternatively, the first MAC CE is used to indicate a repetition number of PDSCH for one time slot, and the second MAC CE is used to indicate repetition numbers of PDSCH for multiple time slots.

Alternatively, the first MAC CE and the second MAC CE are identified using the logical channel identifier (LCID) in a MAC sub header. The first MAC CE includes one field for indicating REP of the PDSCH for one time slot, a length of the second MAC CE is indicated by a length field in the corresponding MAC sub header, and the second MAC CE includes a plurality of fields for indicating REP for each of the plurality of time slots, respectively.

According to a fourth aspect of an embodiment of the disclosure, a method performed by a user equipment is provided, which includes: receiving, from a network node, information related to repetition number (REP) for physical downlink shared channel (PDSCH), through a media access control (MAC) control element (CE); performing the PDSCH transmission, according to the information related to REP.

Alternatively, the method further comprises: receiving radio resource control (RRC) signaling from the network node; wherein, the information related to REP is received through the MAC CE if there is no first information in the RRC signaling for indicating that the information related to REP is indicated through the DCI; or the information related to REP is received through the DCI if there is first information in the RRC signaling for indicating that the information related to REP is indicated through the DCI.

Alternatively, the MAC CE includes: a first MAC CE for indicating a repetition number of PDSCH for one time slot, and a second MAC CE for indicating repetition numbers of PDSCH for a plurality of time slots.

Alternatively, the first MAC CE and the second MAC CE are identified using the logical channel identifier (LCID) in a MAC sub header. The first MAC CE includes one field for indicating REP of the PDSCH for one time slot, a length of the second MAC CE is indicated by a length field in the corresponding MAC sub header, and the second MAC CE includes a plurality of fields for indicating REP for each of the plurality of time slots, respectively.

According to a fifth aspect of an embodiment of the disclosure, a network node is provided, which includes: a transceiver for transmitting and receiving a signal; and a processor coupled to the transceiver and configured to perform the method performed by the network node as described above.

According to a sixth aspect of an embodiment of the disclosure, a user equipment is provided, which includes: a transceiver for transmitting and receiving a signal; and a processor coupled to the transceiver and configured to perform the method performed by the user equipment as described above.

According to a seventh aspect of an embodiment of the disclosure, a computer readable storage medium storing instructions is provided, the instructions, when being executed by at least one processor, cause the at least one processor to perform the method performed by the network node or the method performed by the user equipment as described above.

According to an embodiment of the disclosure, the communication between the terminal and the network node in the NTN system may be improved by enhancing link adaptation.

Furthermore, according to an embodiment of the disclosure, the network node in the NTN system may determine optimal MCS and REP of downlink channels by using appropriate AI-based prediction model and channel related information.

The effects obtainable in the disclosure are not limited to the above-mentioned effects, and other effects not mentioned herein will be clearly understood from the following description by those skilled in the art to which the disclosure belongs.

The beneficial effects brought by the technical solutions provided by the embodiments of the disclosure will be described in the later section in combination with specific optional embodiments, or may be learned from descriptions of the embodiments, or may be learned from implementation of the embodiments.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of wireless network according to an embodiment of the disclosure;

FIG. 2 illustrates an example of base station according to an embodiment of the disclosure;

FIG. 3 illustrates an example of user equipment according to an embodiment of the disclosure;

FIG. 4 illustrates an NTN network architecture of a transparent forwarding mode according to an embodiment of the disclosure;

FIG. 5 illustrates an example of a process of link adaptation according to an exemplary embodiment of the disclosure;

FIG. 6 illustrates an example of a HARQ workflow according to an exemplary embodiment of the disclosure;

FIG. 7 illustrates an example of a CQI feedback latency according to an exemplary embodiment of the disclosure;

FIG. 8 illustrates an example of satellite position changing according to an exemplary embodiment of the disclosure;

FIG. 9 illustrates an example of a HARQ feedback latency according to an exemplary embodiment of the disclosure;

FIG. 10 illustrates an example of a process diagram showing a link adaptation method based on a Transformer neural network according to an exemplary embodiment of the disclosure;

FIG. 11 illustrates an example of DCI format according to an exemplary embodiment of the disclosure;

FIG. 12 illustrates an example of a process of disabling HARQ feedback according to an exemplary embodiment of the disclosure;

FIG. 13 illustrates an example of comprehensive influence of long-term SINR and short-term SINR according to an exemplary embodiment of the disclosure;

FIG. 14 illustrates an example of a process diagram showing a link adaptation method according to an exemplary embodiment of the disclosure;

FIG. 15A illustrates a flowchart of a method performed by a network node according to an exemplary implementation of the disclosure;

FIG. 15B illustrates an example of a process of a method performed by a network node according to an exemplary embodiment of the disclosure;

FIG. 16A illustrates a flowchart of a process for obtaining channel information according to one exemplary embodiment of the disclosure;

FIG. 16B illustrates an example of a process of obtaining CQI information, MCS information and REP information according to an exemplary embodiment of the disclosure;

FIG. 16C illustrates an example of filtering by using a sliding window according to an exemplary embodiment of the disclosure;

FIG. 17A illustrates a flowchart of a process for obtaining channel information according to another exemplary embodiment of the disclosure;

FIG. 17B illustrates an example of a process of obtaining BLER information according to an exemplary embodiment of the disclosure;

FIG. 18A illustrates a flowchart of a process, according to HARQ ACK/NACK feedback for each time unit, for determining HARQ ACK/NACK information for the time unit according to an exemplary embodiment of the disclosure;

FIG. 18B illustrates an example of HARQ ACK/NACK feedback and PDSCH transmission number information obtained by a network node according to an exemplary embodiment of the disclosure;

FIG. 18C illustrates an example of HARQ feedback regarding a first transmission for each time unit within a first time unit determined by step S1830 according to an exemplary embodiment of the disclosure;

FIG. 19A illustrates a flowchart of a process for determining HARQ ACK/NACK information for a PDSCH according to an RLC status PDU according to an exemplary embodiment of the disclosure;

FIG. 19B illustrates a correspondence relationship between SN, SO of an RLC PDU and a plurality of time units in the first time unit according to one exemplary embodiment of the disclosure;

FIG. 19C illustrates an example of a status report of a RLC layer according to an exemplary embodiment of the disclosure;

FIG. 19D illustrates an example of a process for determining HARQ ACK/NACK information of each time unit, based on o ACK/NACK feedback corresponding to each RLC SN and correspondence relationship, according to one exemplary embodiment of the disclosure;

FIG. 20 illustrates an example of calculating BLER information, by filtering by using a sliding window according to an exemplary embodiment of the disclosure;

FIG. 21A illustrates a flowchart of a process for obtaining SINR information in channel-related information according to another exemplary embodiment of the disclosure;

FIG. 21B illustrates an example of a process for obtaining SINR information according to an exemplary embodiment of the disclosure;

FIG. 22A illustrates a flowchart of a process for determining first path loss between a network node and a UE according to ephemeris information according to an exemplary embodiment of the disclosure;

FIG. 22B illustrates an example of basic path loss PLb determined according to ephemeris information for a plurality of time slots (e.g., T1, T2, T3 . . . ) according to an exemplary embodiment of the disclosure;

FIG. 22C illustrates an example of zenith attenuation according to an exemplary embodiment of the disclosure;

FIG. 22D illustrates an example of path loss PL determined for a plurality of historical time slots (e.g., T1, T2, T3 . . . ) according to an exemplary embodiment of the disclosure;

FIG. 22E illustrates an example of SINR information for each time slot determined according to signal received power and signal noise of UE at each time slot (i.e., T1, T2, T3 . . . ) according to an exemplary embodiment of the disclosure;

FIG. 23 illustrates a flowchart of a process for determining SINR information, based on estimated signal received power of a UE and signal noise, according to one exemplary embodiment of the disclosure;

FIG. 24A illustrates an example of corrected SINR information determined, based on corrected signal received power and corrected signal noise of each historical time slot, according to one exemplary embodiment of the disclosure;

FIG. 24B illustrates an example of SINR filtering by using a sliding window according to an exemplary embodiment of the disclosure;

FIG. 25 illustrates a flowchart of a process for predicting information related to MCS and REP for PDSCH based on channel-related information through an AI network according to an exemplary embodiment of the disclosure;

FIG. 26A illustrates an example of a LSTM-based first neural network showing an exemplary embodiment according to the disclosure;

FIG. 26B illustrates an example of a detailed structure of the LSTM-based first neural network according to an exemplary embodiment of the disclosure;

FIG. 26C illustrates an example of MCS and REP prediction and transmission according to an exemplary embodiment of the disclosure;

FIG. 27A illustrates an example of a structure of a first MAC CE and its corresponding MAC sub-header according to an exemplary embodiment of the disclosure;

FIG. 27B illustrates an example of a structure of a second MAC CE and its corresponding MAC sub-header according to an exemplary embodiment of the disclosure;

FIG. 28 illustrates an example of predicting MCS and REP according to channel information according to an exemplary embodiment of the disclosure;

FIG. 29 illustrates a flowchart of a method performed by a UE according to an exemplary embodiment of the disclosure;

FIG. 30 illustrates a method performed by a network node according to another exemplary embodiment of the disclosure; and

FIG. 31 illustrates a method performed by a network node according to another exemplary embodiment of the disclosure.

### DETAILED DESCRIPTION

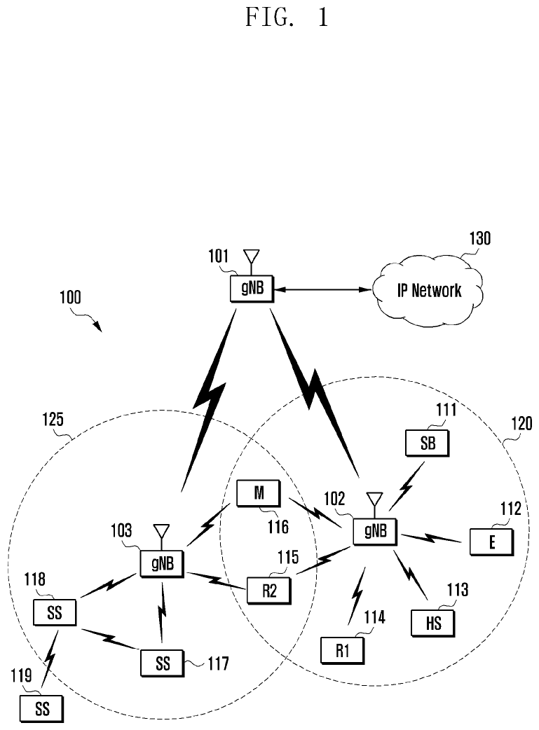

FIGS. 1 through 31, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Those of ordinary skill in the art will recognize that various changes and modifications of the various embodiments described herein can be made without departing from the scope and spirit of the disclosure. In addition, descriptions of well-known functions and constructions may be omitted for clarity and conciseness.

In order to make the objectives, technical schemes and advantages of the embodiments of the disclosure, a clear and complete description will be made with respect to the technical schemes of the embodiments of the disclosure, in conjunction with the accompanying drawings of the embodiments of the disclosure. Apparently, the described embodiments are a part of the embodiments of the disclosure, not all of the embodiments. Based on the described embodiments of the disclosure, all other embodiments obtained by common skilled in the art without creative labor belong to the protection scope of the disclosure.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Furthermore, the expressions “if” and “in case that” as used in the present specification or claims may, depending on the context, be interpreted to mean “when,” “in response to,” “based on,” or “according to,” and such expressions may be used interchangeably. In addition, other expressions having substantially the same meaning may also be used in place of these expressions, as long as the technical features of the present disclosure are not impaired. Furthermore, the term “configured” to indicate that predetermined information is set by a base station or a network may imply that the predetermined information is received via a predetermined message (for example, an RRC message).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As described above, it should be noted that each block of the flowcharts and combinations of the flowcharts described in the disclosure may be performed by one or more computer programs including instructions. The entirety of the one or more computer programs may be stored in a single memory device, or the one or more computer programs may be stored in a plurality of memory devices in a distributed manner.

In addition, the functions or operations described in the disclosure may be processed by a single processor or a combination of processors. The single processor or the combination of processors may be a circuit that performs processing and may include an application processor (AP, e.g., a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near-field communication (NFC) chip, a connectivity chip, a sensor controller, a touch controller, a fingerprint sensor controller, a display driver integrated circuit (IC), an audio codec (CODEC) chip, a universal serial bus (USB) controller, a camera controller, an image processing IC, a microprocessor unit (MPU), a system on chip (SoC), an IC, or a similar circuit.

Furthermore, it should be noted that various embodiments in the claims and descriptions of the disclosure may be implemented in the form of hardware, software, or a combination of hardware and software. Such software may be stored in a non-transitory computer-readable storage medium. The non-transitory computer-readable storage medium stores one or more computer programs (software modules), and the one or more computer programs include computer-executable instructions which, when executed individually or collectively by one or more processors of an electronic device, operate the electronic device to perform the method according to the disclosure.

The software may be stored in a transient or non-transitory storage device, for example, in the form of read-only memory (ROM) (regardless of whether it is erasable or rewritable), or random access memory (RAM), memory chips, devices, or integrated circuits (ICs). Also, the software may be stored in optically or magnetically readable media such as compact discs (CDs), digital versatile discs (DVDs), magnetic disks, or magnetic tapes. It should be understood that the storage devices and storage media are examples of non-transitory machine-readable storage media suitable for storing a program for implementing various embodiments of the disclosure.

Accordingly, various embodiments provide a program including code for implementing a device or method according to any one of the claims of the disclosure, and a non-transitory machine-readable storage medium storing such a program.

Definitions for other certain words and phrases are provided throughout the disclosure. Those of ordinary skill in the art should understand that in many if not most instances, such definitions apply to prior as well as future uses of such defined words and phrases.

The figures included herein, and the various embodiments used to describe the principles of the disclosure are by way of illustration only and should not be construed in any way to limit the scope of the disclosure. Further, those skilled in the art will understand that the principles of the disclosure may be implemented in any suitably arranged wireless communication system.

FIGS. 1-3 below describe various embodiments of the disclosure implemented in wireless communications systems. The descriptions of FIGS. 1-3 are not meant to imply physical or architectural limitations to the manner in which different embodiments may be implemented. Different embodiments of the disclosure may be implemented in any suitably-arranged communications system.

FIG. 1 illustrates an example wireless network according to embodiments of the disclosure.

The embodiment of the wireless network shown in FIG. 1 is for illustration only. Other embodiments of the wireless network 100 could be used without departing from the scope of the disclosure.

As shown in FIG. 1, the wireless network includes a base station (next generation nodeB, gNB or gNodeB) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R1); a UE 115, which may be located in a second residence (R2); and a UE 116, which may be a mobile device (M), such as a cell phone, a wireless laptop, a wireless personal digital assistant (PDA), or the like. The gNB 103 provides wireless broadband access to the network 130 for a second plurality of UEs within a coverage area 125 of the gNB 103. The second plurality of UEs includes the UE 115 and the UE 116, as well as subscriber stations (SS, for example, UEs) 117, 118 and 119. In some embodiments, one or more of the gNBs 101-103 may communicate with each other and with the UEs 111-116 using existing wireless communication techniques, and one or more of the UE 111-119 may communicate directly with each other (e.g., UEs 117-119) using wireless communication techniques.

Depending on the network type, the term “base station” or “BS” can refer to any component (or collection of components) configured to provide wireless access to a network, such as transmit point (TP), transmit-receive point (TRP), an enhanced (or “evolved”) base station (eNodeB or eNB), a 5G base station (gNB), a macrocell, a femtocell, a wireless fidelity (WiFi) access point (AP), or other wirelessly enabled devices. Base stations may provide wireless access in accordance with one or more wireless communication protocols, e.g., 3GPP 5G New Radio (NR), Long Term Evolution (LTE), LTE Advanced (LTE-A), high speed packet access (HSPA), Wi-Fi 802.11a/b/g/n/ac, etc. For the sake of convenience, the various names for a base station-type apparatus and functionality are used interchangeably in this patent document to refer to network infrastructure components that provide wireless access to remote terminals. Also, depending on the network type, the term “user equipment” (UE) can refer to any component such as a mobile station (MS), subscriber station (SS), remote terminal, wireless terminal, receive point, or user equipment. For the sake of convenience, the various names for a user equipment-type device and functionality are used interchangeably in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-119 include circuitry, programing, or a combination thereof. In certain embodiments, and one or more of the gNBs 101-103 includes circuitry, programing, or a combination thereof.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

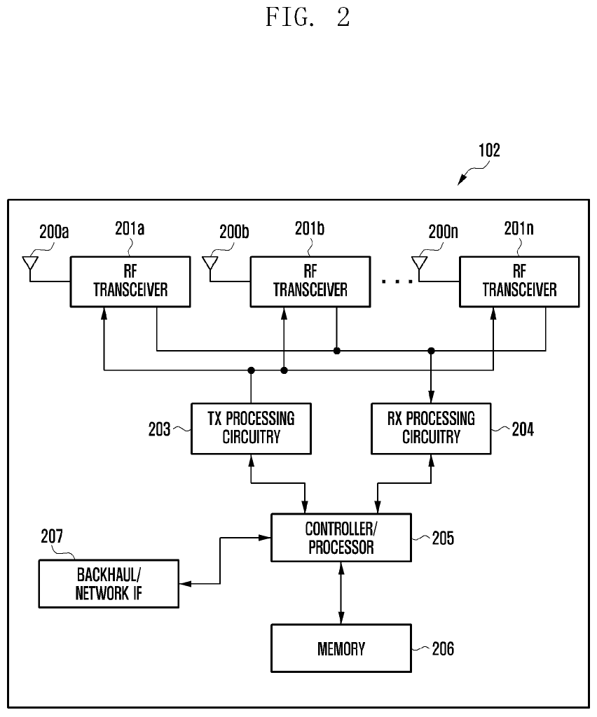

FIG. 2 illustrates an example base station according to embodiments of the disclosure.

The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the disclosure to any particular implementation of a gNB.

As shown in FIG. 2, the gNB 102 includes plurality of antennas 200a-200n, plurality of radio frequency (RF) transceivers 201a-201n, transmit (TX) processing circuitry 203, and receive (RX) processing circuitry 204. The gNB 102 also includes a controller/processor 205, a memory 206, and a backhaul or network interface 207.

The RF transceivers 201a-201n receive, from the antennas 200a-200n, incoming RF signals, such as signals transmitted by UEs in the network 100. The RF transceivers 201a-201n down-convert the incoming RF signals to generate intermediate frequency (IF) or baseband signals. The IF or baseband signals are sent to the RX processing circuitry 204, which generates processed baseband signals by filtering, decoding, and/or digitizing the baseband or IF signals. The RX processing circuitry 204 transmits the processed baseband signals to the controller/processor 205 for further processing.

The TX processing circuitry 203 receives analog or digital data (such as voice data, web data, electronic mail, or interactive video game data) from the controller/processor 205. The TX processing circuitry 203 encodes, multiplexes, and/or digitizes the outgoing baseband data to generate processed baseband or IF signals. The RF transceivers 201a-201n receive the outgoing processed baseband or IF signals from the TX processing circuitry 203 and up-converts the baseband or IF signals to RF signals that are transmitted via the antennas 201a-201n.

The controller/processor 205 can include one or more processors or other processing devices that control the overall operation of the gNB 102. For example, the controller/processor 205 could control the reception of forward channel signals and the transmission of reverse channel signals by the RF transceivers 201a-201n, the RX processing circuitry 204, and the TX processing circuitry 203 in accordance with well-known principles. The controller/processor 205 could support additional functions as well, such as more advanced wireless communication functions.

For instance, the controller/processor 205 could support beam forming or directional routing operations in which outgoing signals from plurality of antennas 200a-200n are weighted differently to effectively steer the outgoing signals in a desired direction. Any of a wide variety of other functions could be supported in the gNB 102 by the controller/processor 205.

The controller/processor 205 is also capable of executing programs and other processes resident in the memory 206, such as an operating system (OS). The controller/processor 205 can move data into or out of the memory 206 as required by an executing process.

The controller/processor 205 is also coupled to the backhaul or network interface 207. The backhaul or network interface 207 allows the gNB 102 to communicate with other devices or systems over a backhaul connection or over a network. The interface 207 could support communications over any suitable wired or wireless connection(s). For example, when the gNB 102 is implemented as part of a cellular communication system (such as one supporting 5G, LTE, or LTE-A), the interface 207 could allow the gNB 102 to communicate with other gNBs over a wired or wireless backhaul connection. When the gNB 102 is implemented as an access point, the interface 207 could allow the gNB 102 to communicate over a wired or wireless local area network or over a wired or wireless connection to a larger network (such as the Internet). The interface 207 includes any suitable structure supporting communications over a wired or wireless connection, such as an Ethernet or RF transceiver.

The memory 206 is coupled to the controller/processor 205. Part of the memory 206 could include a random access memory (RAM), and another part of the memory 206 could include a Flash memory or other read only memory (ROM).

Although FIG. 2 illustrates one example of gNB 102, various changes may be made to FIG. 2. For example, the gNB 102 could include any number of each component shown in FIG. 2. As a particular example, an access point could include a number of interfaces 207, and the controller/processor 205 could support routing functions to route data between different network addresses. As another particular example, while shown as including a single instance of TX processing circuitry 203 and a single instance of RX processing circuitry 204, the gNB 102 could include plurality of instances of each (such as one per RF transceiver). Also, various components in FIG. 2 could be combined, further subdivided, or omitted and additional components could be added according to particular needs.

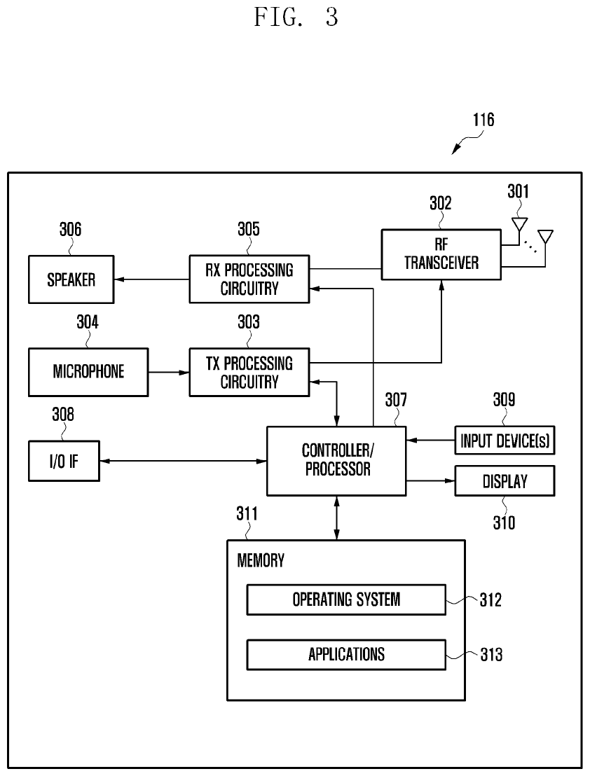

FIG. 3 illustrates an example user equipment according to embodiments of the disclosure.

The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the disclosure to any particular implementation of a UE.

As shown in FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller or processor 307, an input/output (I/O) interface (IF) 308, an input device 309, a touchscreen display 310, and a memory 311. The memory 311 includes an OS 312 and one or more applications 313.

The RF transceiver 302 receives, from the antenna 301, an incoming RF signal transmitted by a gNB of the network 100. The RF transceiver 302 down-converts the incoming RF signal to generate an IF or baseband signal. The IF or baseband signal is sent to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 can include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments, the processor 307 includes at least one microprocessor or microcontroller.

The processor 307 is also capable of executing other processes and programs resident in the memory 311, such as processes for channel state information (CSI) reporting on uplink channel. The processor 307 can move data into or out of the memory 311 as required by an executing process. In some embodiments, the processor 307 is configured to execute the application 313 based on the OS 312 or in response to signals received from gNBs or an operator. The processor 307 is also coupled to the I/O interface 308, which provides the UE 116 with the ability to connect to other devices, such as laptop computers and handheld computers. The I/O interface 308 is the communication path between these accessories and the processor 307.

The processor 307 is also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 is coupled to the processor 307. Part of the memory 311 could include RAM, and another part of the memory 311 could include a Flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into plurality of processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

NTN is a direct communication technology between terminal and satellite based on NR technology specified by 3GPP, and is an important supplement to a terrestrial cellular communication technology. The NTN implements NR communication through the satellite or an unmanned aerial vehicle platform. In a place where a terrestrial network equipment cannot be widely used, 5G coverage can be further improved by adopting NTN coverage. For example, in extreme areas such as deserts and oceans, 5G network coverage can be achieved by adopting NTN.

The NTN Network architecture is similar to a 5G system. It is divided into two parts, namely a 5G Core (5GC) and a 5G access network (i.e., next generation radio access network (NG-RAN)), wherein the 5GC includes an access and mobility management function (AMF) and a user plane function (UPF); the 5G access network includes two parts of a ground station and a satellite. The ground station includes an NTN base station and an NTN Gateway. An NTN UE accesses the 5GC network through the NG-RAN.

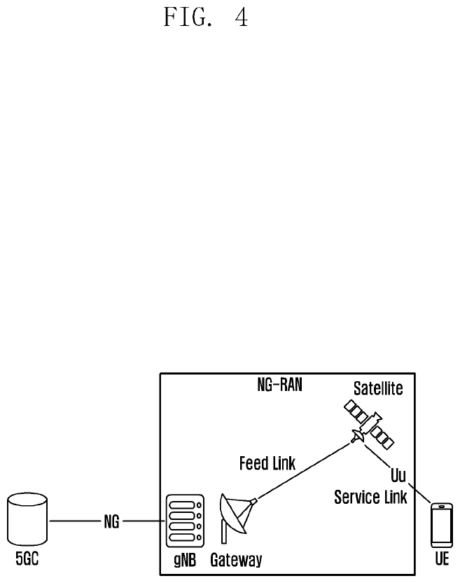

3GPP defines two kinds of NTN network architectures. The first kind of the NTN network architecture is a transparent forwarding mode, that is, the satellite only forwards and amplifies a communication signal, and does not perform any signal processing. The other kind of the NTN network architecture is a regenerative mode, that is, the satellite contains functions of the NTN base station, which can process a 5G signal. A communication process of the NTN network is introduced by referring to FIG. 4 and taking the transparent forwarding mode as an example below.

FIG. 4 is a diagram showing an NTN network architecture of a transparent forwarding mode.

As shown in FIG. 4, the 5GC is connected to the NTN base station through a Next Generation (NG) interface. The NTN base station is located on the ground and is connected to the NTN gateway, and the NTN gateway is connected to the satellite through a feed link, wherein the feed link may be implemented by adopting a 3GPP/non-3GPP wireless interface. An NTN packet is connected to a UE through a 5G Uu interface and a service link.

The satellite in NTN includes three kinds of satellites, namely, a Low Earth orbit (LEO) satellite, a Medium Earth orbit (MEO) satellite, and a Geosynchronous Earth orbit (Geosynchronous Earth orbit) satellite. Table 1 below shows a satellite altitude, a maximum transmission delay between the satellite and the UE, and a maximum Round Trip Time (RTT) of each kind of satellite.

TABLE 1

| | | | Maximum | |
|---|---|---|---|---|
| | | | transmission | |
| | Altitude of | Satellite | delay between | Maximum RTT |
| | satellite | moving | satellite | between satellite |
| | (km) | speed (Km/s) | and UE (ms) | and UE (ms) |
| LEO | 300-1500 | 7.56 | 30 | 60 |
| MEO | 7000-25000 | 7.56 | 90 | 180 |
| GEO | 35786 | 0 | 280 | 560 |

As can be seen from the above table, the NTN incurs a higher transmission delay than that of the terrestrial cellular network, due to a long distance between the NTN UE and the satellite; For LEO and MEO satellite systems, the satellites may orbit the earth in a high-speed circular motion, which may cause huge Doppler shift changes and time delay changes. Therefore, for the NTN, how to improve data transmission speed of the NTN base station as much as possible in a state of a large delay and a large Doppler frequency shift is the biggest challenge.

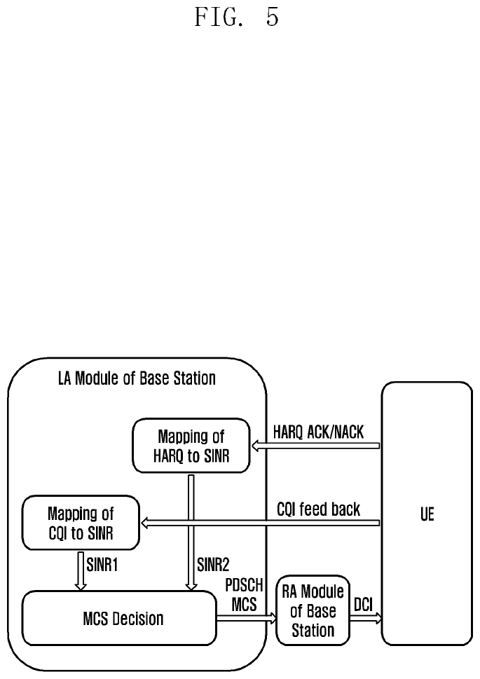

The wireless communication system may improve a data transmission rate by adopting a link adaptation method. Link adaptation refers to a Scheme that selects a modulation and coding scheme (MCS) matching with a channel according to a current channel state, to obtain a maximum throughput of the system. A process of link adaptation is described in detail by referring to FIG. 5 below.

FIG. 5 is a diagram showing a process of link adaptation.

In step S501, a base station (e.g., 5G base station) determines signal to interference plus noise ratio (SINR) based on channel state information (CSI) fed back by a UE, which is used to represent quality of a wireless communication channel. The CSI may include a channel quality indicator (CQI), in addition, it may also include a rank indication (RI), a precoding matrix indicator (PMI), etc.

Specifically, the UE may obtain the CSI by measuring a downlink signal (for example, a Channel State Information Reference Signal (CSI-RS)) transmitted by the base station, and feed the CSI back to the base station. The base station may convert the CQI included in the CSI into the SINR according to the currently known methods.

In step S502, the base station may adjust the SINR determined through step S501, according to HARQ ACK/NACK fed back by the UE.

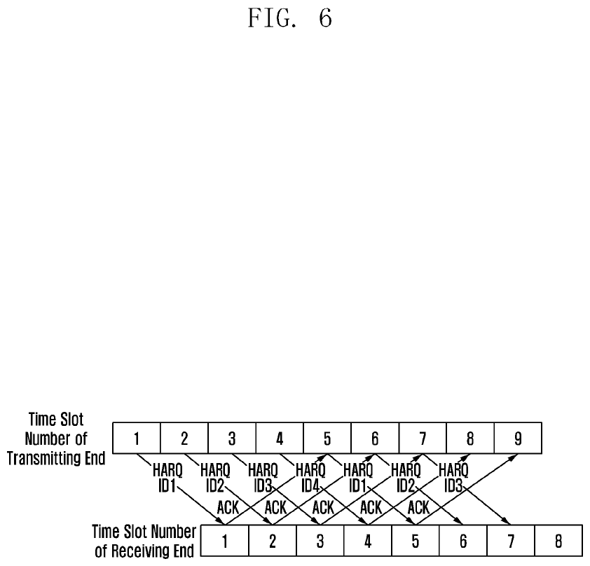

Specifically, the 3GPP protocol adopts a stop-and-wait HARQ, that is, after a transmitter transmits a data packet, it may be considered to wait for a HARQ feedback (i.e., HARQ ACK/NACK) from the receiver before transmitting the next data packet. The HARQ ACK is used to indicate that the current PDSCH is correctly received and demodulated by the UE, and the HARQ NACK is used to indicate that the PDSCH is not correctly received and demodulated by the UE. In order to improve the efficiency of stop-and-wait HARQ, the 3GPP protocol adopts N-process stop-and-wait HARQ, that is, the transmitter executes N different stop-and-wait protocols in parallel on channels, and uses gaps between different channels to interleave data and signaling transfer, thereby improving channel utilization, as shown in FIG. 6.

FIG. 6 is a diagram showing one example of a HARQ workflow, wherein the number of HARQ processes is determined by RTT between the base station and the UE. When the maximum RTT is 4 time slots, the number of HARQ processes is performed to be set to 4. The base station adopts a HARQ process ID1 to transmit PDSCH data in time slot 1 and receives HARQ ACK/NACK feedback in time slot 5, and then uses HARQ process ID1 to transmit PDSCH data in time slot 5. Before the base station receives the feedback of HARQ process ID1, the base station performs operations to use HARQ processes ID2, ID3 and ID4 to transmit PDSCH data, in time slots 2, 3 and 4, respectively.

Whether the current PDSCH is correctly demodulated may be represented by HARQ ACK and NACK feedback from the UE. If the HARQ feedback is NACK, it indicates that a MCS of the current PDSCH is higher than the MCS that the current wireless channel quality may support, which results in the current PDSCH may not be correctly demodulated, so the MCS may be further reduced. In other words, the SINR determined in step S501 may be corrected downward. Conversely, if the HARQ feedback is ACK, it indicates that the MCS of the current PDSCH is lower than the MCS that the current wireless channel quality may support, therefore, in order to further improve transmission efficiency, an attempt may be made to increase MCS, that is, the SINR determined in step S501 may be corrected upward.

From the above description, it may be seen that, for NTN, due to a large delay of information transmission between the NTN UE and the NTN base station (which is much higher than a delay of a wireless communication network of 0.033 ms), for example, taking a MEO satellite as an example, the maximum transmission delay from the NTN UE to the NTN base station is about 90 ms, therefore, the link adaptation method used in the wireless communication network is no longer applicable to the NTN. The specific reasons are as follows:

Reason 1: CQI feedback information is invalid due to the delay.

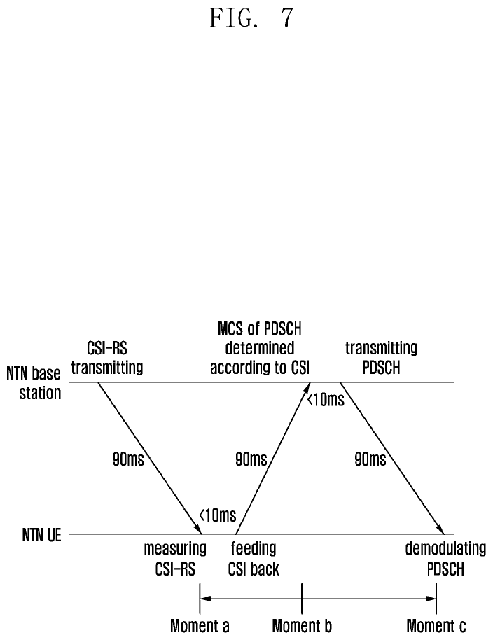

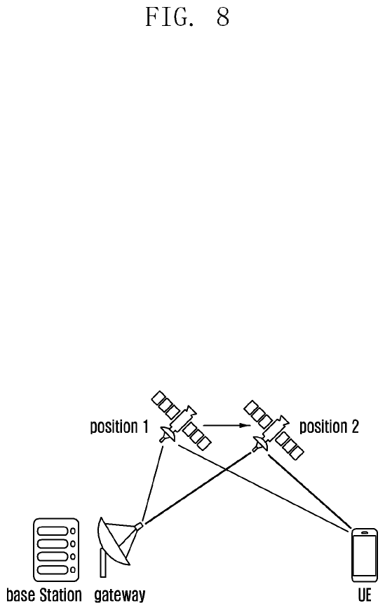

FIG. 7 is a diagram showing one example of a CQI feedback latency and FIG. 8 is a diagram showing one example of satellite position changing.

Specifically, as shown in FIG. 7, a NTN UE receives a CSI-RS transmitted by a NTN base station at a moment a, obtains a CSI after performing measurement, and feeds the CSI back to the NTN base station; the NTN base station receives the CSI fed back from the NTN UE at a moment b, determines a MCS of a PDSCH based on the received CSI, and transmits the PDSCH to the NTN UE; finally, the NTN UE receives the PDSCH at a moment c and demodulates the same.

Through the above process, it may be seen that, there is a delay of about 200 ms between the moment a and the moment c in NTN, a position of a satellite has changed significantly in this delay due to high-speed movement of the satellite. As shown in FIG. 8, the satellite has moved from a position 1 to a position 2.

In other words, the MCS of the PDSCH received by the NTN UE at the moment c is determined according to channel information at the moment a and cannot match a channel at the moment c, which may lead to the following problems: if a channel quality of the PDSCH at the moment c is worse than that of the PDSCH at the moment a, it may cause the NTN UE to fail to demodulate the PDSCH correctly at the moment c and generate a block error rate (BLER); if the channel quality of the PDSCH at the moment c is better than that of the PDSCH at the moment a, the NTN UE may correctly demodulate the PDSCH at the moment c, but in fact, the PDSCH may support a higher MCS at the moment c, which may lead to a lower transmission efficiency.

Reason 2: HARQ BLER information is invalid due to the delay.

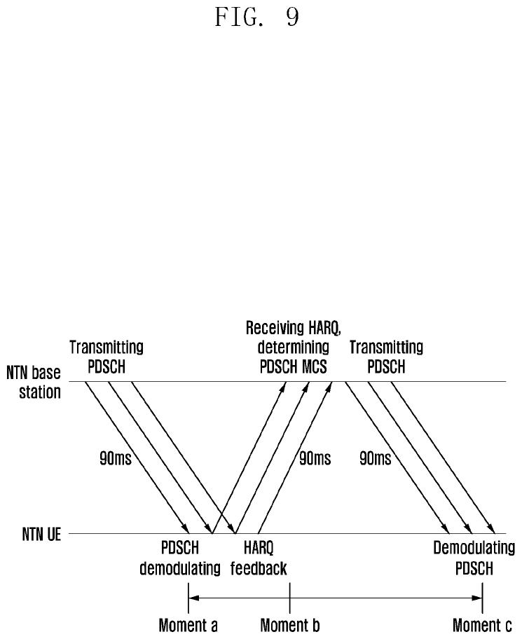

FIG. 9 is a diagram showing one example of a HARQ feedback latency.

When the NTN configures a HARQ feedback function for some HARQ processes, a HARQ feedback (i.e., HARQ ACK/NACK) used in a link adaptation algorithm also has a similar problem mentioned in Reason 1, that is, as shown in FIG. 9, the HARQ feedback at a moment a can no longer accurately reflect a demodulation state at a moment c.

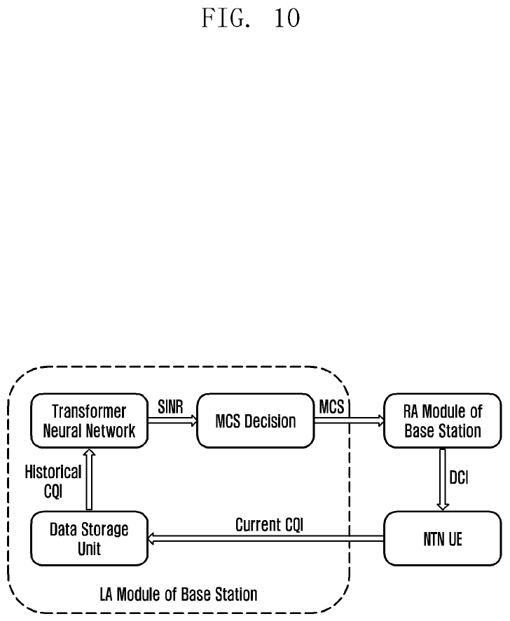

With respect to the above problems, a link adaptation method based on a neural network model may be adopted. The link adaptation method is described with reference to FIG. 10 below.

FIG. 10 is a process diagram showing a link adaptation method based on a Transformer neural network.

In step 1, the NTN UE transmits a current CQI to a data storage unit in the NTN base station. Specifically, the NTN UE may measure a corresponding pilot signal according to a high-level instruction to obtain the CQI, and report the obtained CQI to the NTN base station, wherein the NTN base station may store the received CQI in the data storage unit.

In step 2, the data storage unit may transmit historical CQIs of a plurality of moments (for example, CQIs of a plurality of historical time slots) to a Transformer neural network.

In step 3, the Transformer neural network may use the received historical CQIs of the plurality of moments to predict SINRs of a plurality of future moments (e.g., a plurality of future time slots).

In step 4, a MCS decision module may calculate MCSs of the PDSCH for the plurality of future moments according to the predicted SINRs of the plurality of future moments, and inform the calculated MCSs for the plurality of future moments to a wireless Resource Allocation (RA) module (also known as a scheduling module) of the NTN base station.

In step 5, the RA module of the NTN base station may inform the MCS of the PDSCH for each future time slot to the NTN UE by a DCI.

Through the above method, a problem of mismatch between the MCS of the PDSCH determined by using outdated CQI information and the current channel may be avoided, thus improving a downlink throughput of the NTN base station.

The above method only calculates the MCS of the PDSCH by the predicted SINRs, without considering the number of repetitions of the PDSCH. For the NTN network, due to a relatively high altitude of the satellite, a distance between the NTN UE and the NTN base station is large, which leads to a serious path loss. Even if the PDSCH adopts a lowest MCS, a reliable transmission of the PDSCH cannot be guaranteed in most scenarios, therefore, a large number of repeated transmission are performed to ensure the reliable transmission of the PDSCH. The number of repetitions of the PDSCH may be informed to the NTN UE through the following two methods.

In a method of one exemplary embodiment, as shown in Table 2 below, pdsch-TimeDomainAllocationList may be configured through a Radio Resource Control (RRC) signaling, wherein, in this list, up to 16 PDSCH time domain resource allocations may be configured, and the number of repetitions of the PDSCH may also be preconfigured in the PDSCH time domain resource allocations.

```
TABLE 2
maxNrofDL-Allocations INTEGER ::= 16 -- Maximum number of PDSCH time domain
resource allocations
PDSCH-TimeDomainResourceAllocation-r17 ::= SEQUENCE {
  k0-r17 INTEGER (0..128) → Slot interval between PDCCH and PDSCH
  mappingType-r17 ENUMERATED {typeA, typeB}, → Mapping type of PDSCH
  startSymbolAndLength-r17 INTEGER (0..127), → Starting symbol and symbol length of
PDSCH
  repetitionNumber-r17 ENUMERATED {n2, n3, n4, n5, n6, n7, n8, n16 → Number of
Repetitions of PDSCH
}
```

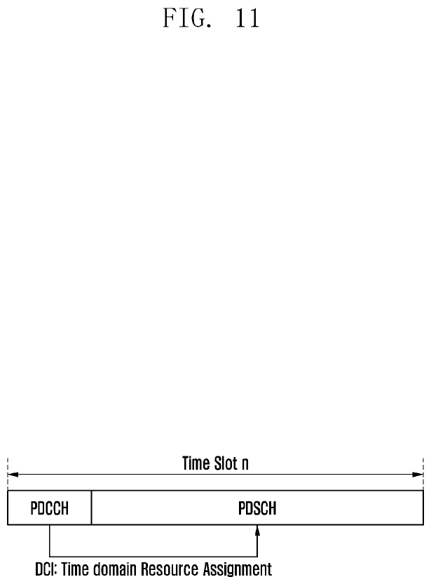

FIG. 11 is a diagram showing one example of DCI format. In a method of another exemplary embodiment, as shown in FIG. 11, the NTN base station may transmit DCI information to the NTN UE by a Physical Downlink Control Channel (PDCCH). A time domain resource assignment field in the DCI is used to indicate a PDSCH time domain resource assignment sequence number of a current PDSCH.

For the two methods mentioned above for informing the number of repetitions of the PDSCH to the NTN UE, the maximum number of repetitions defined by 3GPP is 16. For the NTN, in an extreme coverage case, 32 retransmissions are performed to meet the requirements of reliable transmission. In addition, for the above two methods, 3GPP defines only 8 kinds of repetition number (i.e., n2, n3, n4, n5, n6, n7, n8, n16), it does not cover all 1 to 32 transmissions. In addition, 3GPP only defines up to 16 kinds of PDSCH time domain resource allocations, and in a general case, the NTN base station performs operations to configure at least 2 mapping types (mappingType) and 3 types of OFDM symbol starting positions and lengths. Therefore, for the repetition number, only at most two types may be configured. This may lead to a limited repetition number that may be selected by the link-adaptive method of the NTN, leading to the degradation of performance.

In addition, the SINR of the PDSCH channel through the CQI is predicted via the method described by referring to FIG. 10, which cannot guarantee the reliability of the link adaptation algorithm. Specifically, the CQI fed back by the NTN UE is not always accurate. For example, when the NTN UE is located at an edge of a cell, a signal quality of the CSI-RS transmitted by the NTN base station is poor, therefore, the NTN UE may not be able to obtain an accurate CQI by measuring the CSI-RS. In addition, when the NTN UE reports the CQI to the NTN base station, the NTN UE may correct the CQI according to its own algorithm (such as, adopting different filtering operations, etc.). However, the NTN base station cannot know how the NTN UE corrects the CQI, so the NTN base station cannot obtain a true situation of the current channel.

With respect to the above problems, the link adaptation method in the NTN may further correct the SINR of the PDSCH channel predicted by the CQI, taking into account the HARQ feedback (i.e., HARQ ACK/NACK feedback). However, for NTN, the HARQ feedback is difficult to be directly used for the link adaptation method for the following reasons:

First, due to the large delay of the NTN, HARQ ACK/NACK feedback is out of date. Since it has been described in detail above, it will not be repeated here.

Second, in most scenarios, there is no HARQ ACK/NACK feedback in the NTN, because, in order to ensure that there may be PDSCH scheduling at all time slots, thus improving resource utilization, the 3GPP protocol defines the HARQ feedback off function. This function may turn off HARQ feedback for a HARQ process, the transmitter does not perform operations to wait for HARQ ACK/NACK feedback from the receiver, and may directly use this HARQ process ID again for the next PDSCH transmission.

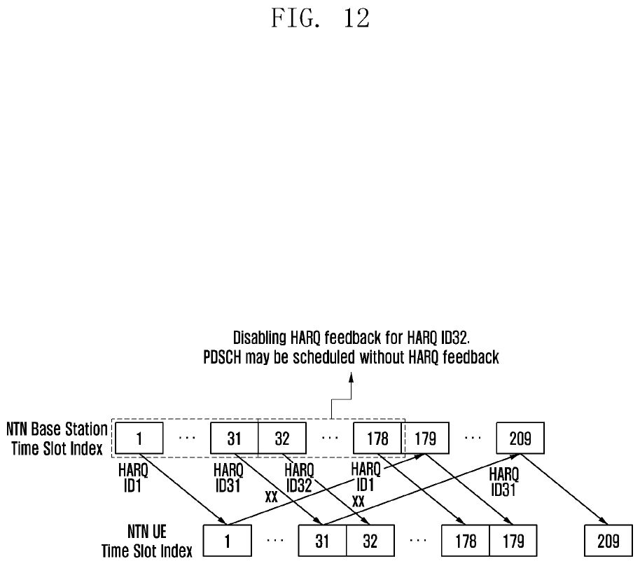

FIG. 12 is a diagram showing a process of disabling HARQ feedback. Specifically, the HARQ working process is described below with reference to FIG. 12 by taking a MEO satellite scenario as an example. The maximum transmission delay between the NTN base station and the NTN UE is 180 ms, and the NTN base station selects one HARQ process ID (for example, process ID=32) so as to turn off its HARQ feedback function.

As shown in FIG. 12, for each of time slots 1-31, there is one HARQ process ID for PDSCH scheduling and receiving HARQ ACK/NACK feedback. The NTN base station receives the HARQ ACK/NACK feedback at time slots 179-209 respectively, and may schedule and transmit PDSCH again after receiving the HARQ ACK/NACK feedback.

For time slots 32-178, the HARQ process ID 32 is adopted for PDSCH transmission, but without waiting for HARQ ACK/NACK feedback, the next PDSCH scheduling and transmission may be directly performed.

Therefore, the HARQ feedback is difficult to be directly used for the link adaptation method for the above reasons.

In addition, the method described by referring to FIG. 10 uses a Transformer neural network to predict SINRs of the plurality of future moments, but the Transformer neural network is actually not suitable for the link adaptation method of the NTN, for the following reasons:

First, the Transformer neural network cannot distinguish between a long-term SINR and a short-term SINR.

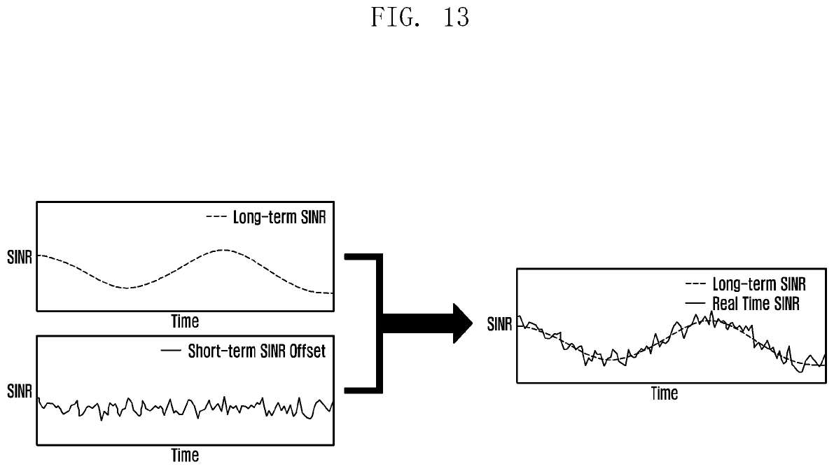

FIG. 13 is a diagram showing a comprehensive influence of long-term SINR and short-term SINR. In the NTN communication system, the MCS and the repetition number of the PDSCH are obtained by the SINR, however, the SINR is determined by SINR large-scale information and SINR small-scale information, therefore, as shown in FIG. 13, the link adaptation method of the NTN performs operations to distinguish between the long-term SINR and the short-term SINR to accurately obtain the channel state information, and then calculates the MCS and/or the repetition number that matches with the channel.

Second, although the Transformer neural network is very powerful, its model is complex, which may lead to an increase in the implementation complexity of the NTN base station, resulting in higher cost.

The disclosure provides a new link adaptation method for the NTN performed by a network node, which may predict the MCS and/or the repetition number (RepetitionNumber, REP) of the PDSCH for a plurality of future time slots.

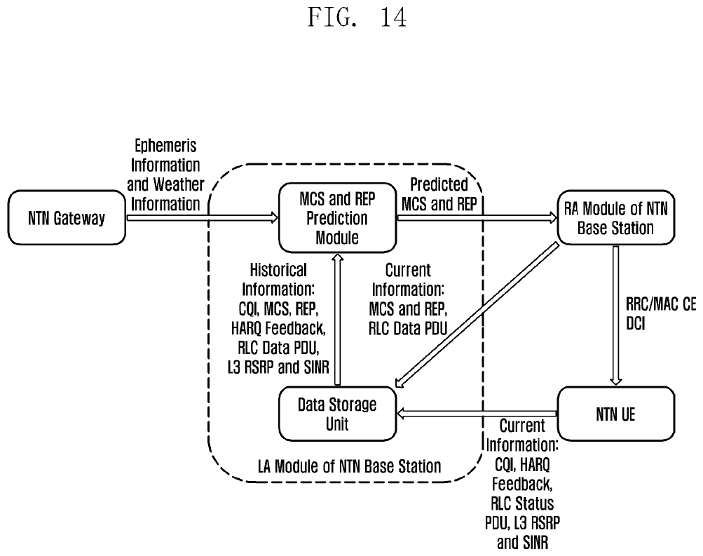

In the disclosure, the network node may be a base station, for example, an NTN base station, but the disclosure is not limited to this, the network node may also be a network server, the network server may communicate with the NTN base station and/or an NTN UE, may predict the MCS and REP of the PDSCH for the plurality of future time slots by performing the link adaptation method mentioned above, and transmit the predicted MCS and REP to the NTN base station and the NTN UE, or to the NTN base station, which forwards the same to the NTN UE. The following description takes an example of a network node as an NTN base station for illustration. In the following description, this link adaptation method is firstly described in general by referring to FIG. 14.

FIG. 14 is a process diagram showing a link adaptation method according to an exemplary embodiment of the disclosure.

In the disclosure, through an AI network, based on the obtained channel-related information of the PDSCH within a first time unit (for example, may include one or more time slots, or may include one or more symbols, but is not limited in the disclosure), only MCS, only REP, or MCS and REP may be predicted. Predicting the MCS and REP is taken as an example for illustration, and the technical solutions of predicting only the MCS and predicting only REP is similar to the predicting the MCS and REP, and thus will not be repeated.

As shown in FIG. 14, the NTN base station may include a link adaptation (LA) module and a resource allocation (RA) module (also known as scheduling module), wherein the LA module of the NTN base station includes a MCS and REP prediction module and a data storage unit. The LA module of the NTN base station receives CQI, HARQ feedback (i.e., HARQ ACK/NACK feedback), radio link control (RLC) status protocol data unit (PDU), and Layer 3 (L3) reference signal received power (RSRP) and SINR from the NTN UE, and stores the received information in the data storage unit. In addition, LA module of the NTN base station also receives MCS and REP as well as RLC PDU data from the RA module of the NTN base station, and stores the received information in the data storage unit. The MCS and REP prediction module may include a multi-scale neural network (MsNet) (i.e., long short-term memory (LSTM)-based first neural network), a block error rate (BLER) processing module, a SINR processing module, and a CQI, MCS, and REP processing module. The MCS and REP prediction module may predict MCS and REP for future time slots through the MsNet based on weather information and ephemeris information received from the NTN gateway as well as historical information received from the data storage unit (i.e., CQI, MCS, REP, HARQ feedback, RLC status PDU, L3 RSRP and SINR), and thereafter, transmit the predicted MCS and REP to the RA module of the NTN base station. The RA module of the NTN base station informs the predicted optimal MCS and REP to the NTN UE by using the RRC, MAC CE, and DCI, thereby ensuring the optimal throughput of the NTN in various scenarios. Meanwhile, the RA module of the NTN base station transmits the predicted MCS and REP as well as the RLC status PDU to the LA module of the NTN base station. The above link adaptation method will be described below in detail with reference to FIGS. 14 to 28.

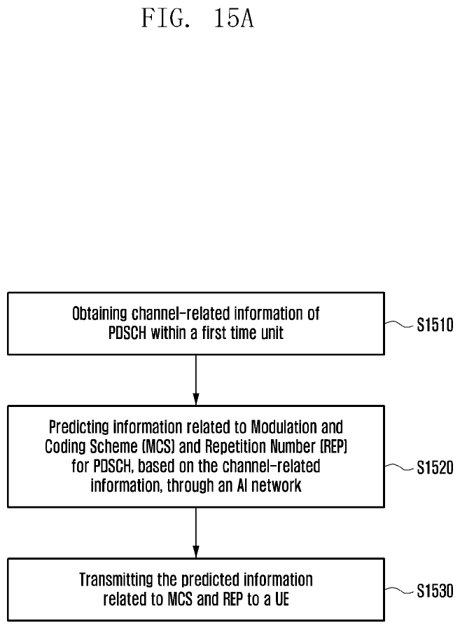

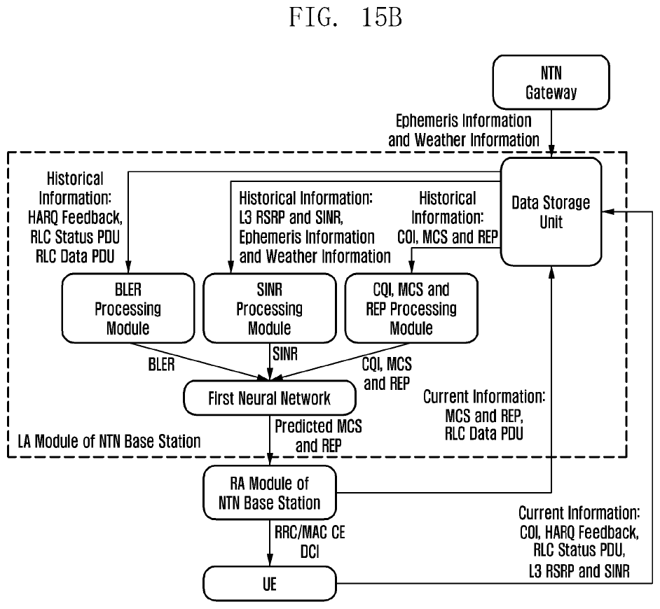

FIG. 15A is a flowchart showing a method performed by a network node according to an exemplary embodiment of the disclosure. FIG. 15B is a process diagram showing a method performed by a network node according to an exemplary embodiment of the disclosure.

In the disclosure, the network node may be a base station, such as NTN base station, but the disclosure is not limited to this, network nodes may also be a network server, and the network server may communicate with the NTN base station and/or the NTN UE, may predict information related to MCS and REP for the PDSCH, and transmit the predicted information related to the MCS and REP for the PDSCH to the NTN base station and the NTN UE, or to the NTN base station, which may forward the same to the NTN UE. The following description takes an example of a network node as an NTN base station for illustration.

As shown in FIG. 15A, in step S1510, channel-related information of PDSCH within a first time unit is obtained. In the disclosure, the first time unit may include at least one time unit, each time unit may represent one time slot or orthogonal frequency division multiplexing (OFDM) symbol, etc. For ease of description, the following description takes an example of each time unit representing one time slot.

Specifically, the channel-related information of the PDSCH includes at least MCS and REP of PDSCH transmission within the first time unit, CQI information, BLER information, and SINR information. To summarize, as shown in FIG. 15B, a BLER processing module obtains the BLER information by processing historical information obtained from a data storage unit (i.e., HARQ feedback, RLC status PDU). In other words, the BLER processing module obtains the BLER information of the PDSCH within each historical time slot by processing the HARQ feedback and RLC status PDU for a plurality of historical time slots (that is, a plurality of time units) obtained from the data memory unit. A SINR processing module obtains SINR information for each historical time slot based on the historical information (i.e., L3 RSRP and SINR, as well as ephemeris information and weather information) obtained from the data storage unit. In other words, the SINR processing module obtains the SINR information by the ephemeris information and weather information as well as the L3 RSRP and SINR for the plurality of historical time slots obtained from the data unit, wherein, the ephemeris information and the weather information may be obtained from the NTN gateway. In addition, the CQI, MCS and REP processing module obtain CQI information, MCS information and REP information for each historical time slot by processing the historical information (that is, historical CQI, MCS and REP) obtained from the data storage unit, and then, the obtained CQI information, MCS information and REP information are input to the AI network (e.g., the first neural network), namely, the LSTM-based first neural network (i.e., MsNet) described later with reference to FIG. s 26A and 26B. The process of obtaining the above various information included in the channel-related information is described below, respectively.

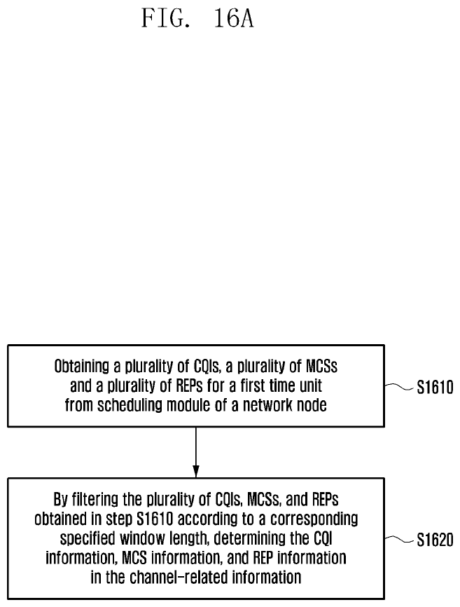

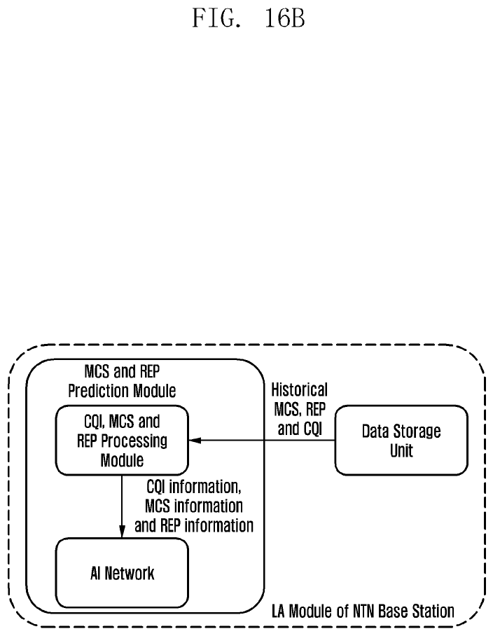

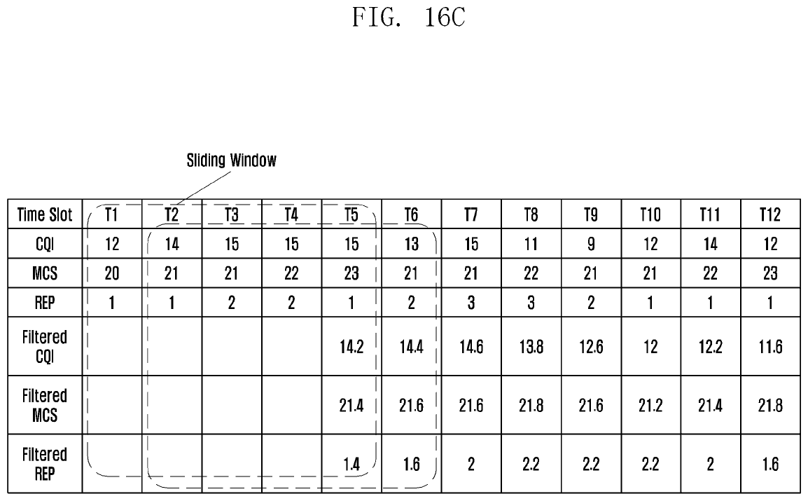

FIG. 16A is a flowchart showing a process of obtaining channel information according to an exemplary embodiment of the disclosure. FIG. 16B is a schematic diagram showing a process of obtaining CQI information, MCS information and REP information according to an exemplary embodiment of the disclosure.

As shown in FIG. 16A, in step S1610, a plurality of CQIs, a plurality of MCSs and a plurality of REPs for a first time unit are obtained from a scheduling module of a network node. By referring to FIG. 15B, the RA module of the NTN base station (i.e., the scheduling module of the network node) transmits the MCS and the REP as well as the RLC status PDU obtained from the LA module of the base station to the data storage unit for storage. In this case, as shown in FIG. 16B, a CQI, MCS, and REP processing module in a MCS and REP prediction module obtains the CQIs, MCSs, and REPs for a plurality of historical time slots from the data storage unit. Specifically, in the exemplary embodiment of the disclosure, the historical time slot represents a time slot corresponding to a previous time moment, in other words, a time slot that has previously been used for transmission between a UE (e.g., the NTN UE) and the network node. In addition, the CQI may be the CQI received by the network node from the UE, and the CQI received by the network node may be stored in the data storage unit. Since the process of how the UE determines the CQI has been described above, it will not be further described here.

In step S1620, the CQI information, the MCS information, and the REP information in the channel related information are determined, by filtering the plurality of CQIs, MCSs, and REPs obtained in step S1610 according to a corresponding specified window length. That is, the CQI information, the MCS information and the REP information for each time unit (for example, each historical time slot) within the first time unit are obtained. Specifically, as shown in FIG. 16C, the filtered CQI, the filtered MCS and the filtered REP are obtained by a moving average filtering method, so as to determine the CQI information, the MCS information and the REP information for each time unit (for example, each time slot). Assuming that the sliding window is 5, the CQI information, the MCS information and the REP information for each historical time slot may be equal to an average value of respective values within the sliding window, respectively. In addition, as shown in FIG. 16B, the CQI, MCS and REP processing module inputs the determined CQI information, MCS information and REP information to an AI network (for example, a first neural network based on a long short-term memory network), to predict the information related to MCS and REP for the PDSCH.

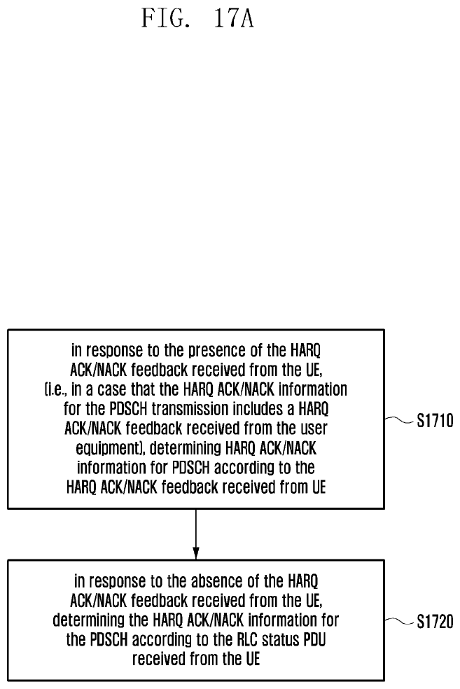

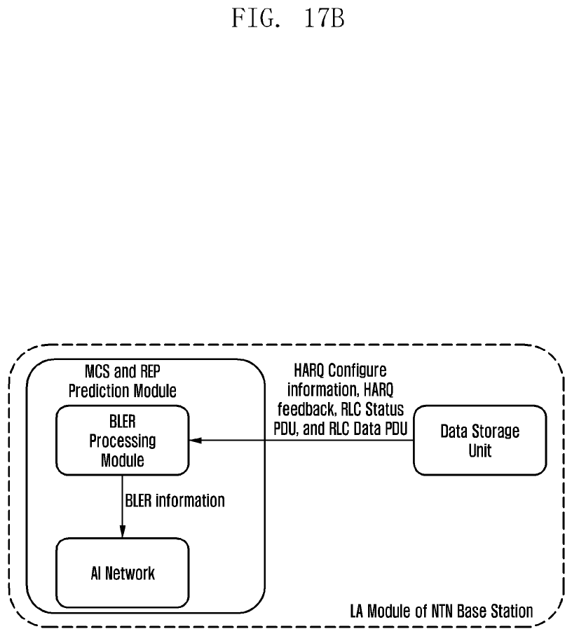

In an exemplary embodiment of the disclosure, the BLER information in the channel-related information is obtained based on hybrid automatic retransmission request (HARQ) ACK/NACK information for the PDSCH transmission, at least part of the HARQ ACK/NACK information for the PDSCH transmission is obtained based on radio link control (RLC) status protocol data unit (PDU). A process of obtaining the HARQ ACK/NACK information for the PDSCH transmission is firstly described below with reference to FIGS. 17A to 19D.

FIG. 17A is a flowchart showing a process of obtaining HARQ ACK/NACK information for PDSCH transmission according to another exemplary embodiment of the disclosure. FIG. 17B is shows a schematic diagram showing a process of obtaining BLER information according to an exemplary embodiment of the disclosure.

To summarize, as shown in FIG. 17B, a BLER module in a MCS and REP prediction module may obtain HARQ configuration information, HARQ feedback (i.e., HARQ ACK/NACK feedback), RLC status PDU from a data storage unit, and determines the BLER information by using different information according to whether there is a HARQ feedback for each time unit within a first time unit.

Specifically, within the first time unit, there is a HARQ ACK/NACK feedback for some time units (for example, historical time slots), and there is no HARQ ACK/NACK feedback for some other time units (for example, historical time slots). Therefore, for the time units for which there is the HARQ ACK/NACK feedback and the time units for which there is not the HARQ ACK/NACK feedback, the disclosure adopts different methods to determine feedback information (namely, HARQ ACK/NACK information) thereof. This is described in detail below.

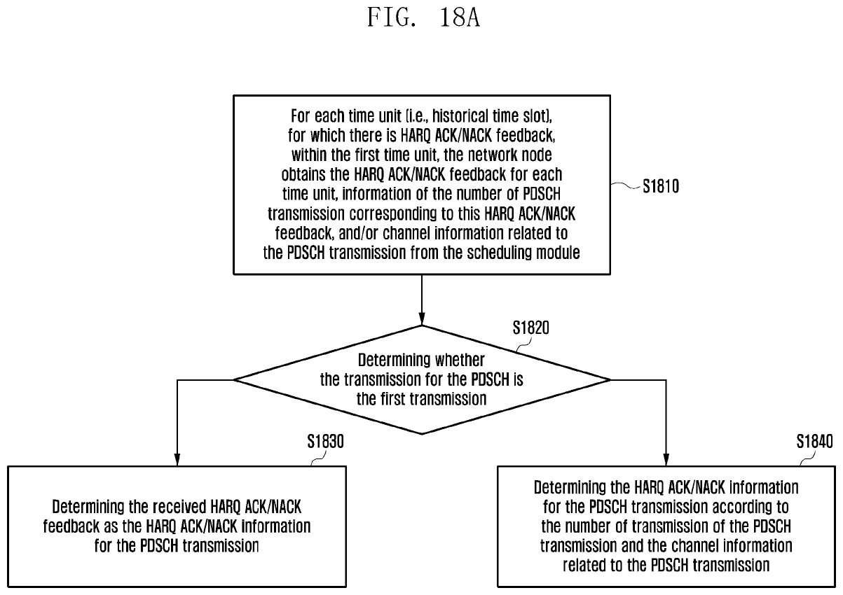

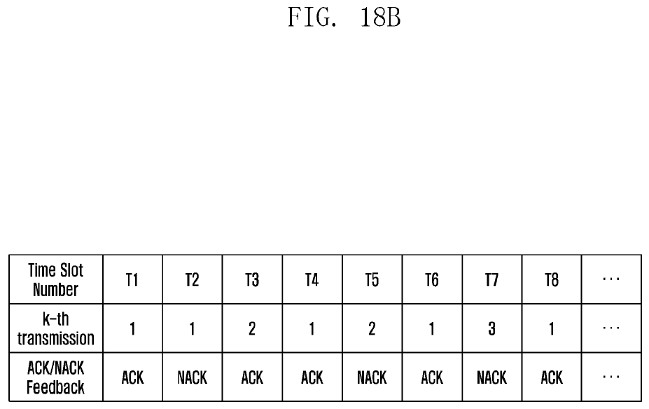

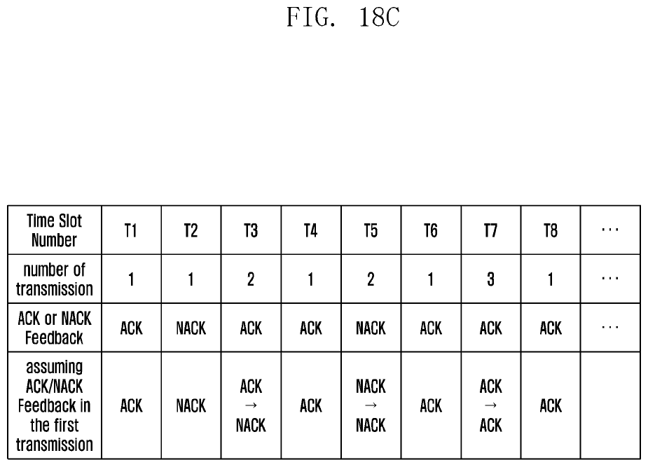

In step S1710, in response to the presence of the HARQ ACK/NACK feedback received from the UE, (i.e., in a case that the HARQ ACK/NACK information for the PDSCH transmission includes a HARQ ACK/NACK feedback received from the user equipment), HARQ ACK/NACK information for PDSCH is determined based on the HARQ ACK/NACK feedback received from UE. This is described in detail below with reference to FIGS. 18A, 18B and 18C.

FIG. 18A is a flowchart showing a process of, according to HARQ ACK/NACK feedback for each time unit, determining HARQ ACK/NACK information for a time unit according to an exemplary embodiment of the disclosure.

As shown in FIG. 18A, in step S1810, for each time unit (i.e., historical time slot), for which there is HARQ ACK/NACK feedback, within the first time unit, the network node obtains the HARQ ACK/NACK feedback for each time unit, information of the number of PDSCH transmission corresponding to this HARQ ACK/NACK feedback, and/or channel information related to the PDSCH transmission from the scheduling module.

In step S1820, whether the transmission for the PDSCH is the first transmission is determined according to the information of the number of the PDSCH transmission. FIG. 18B shows an example of the HARQ ACK/NACK feedback, the information of the number of PDSCH transmission obtained by the network node.

If the PDSCH transmission for the received HARQ ACK/NACK feedback is the first transmission, in the step S1830, the received HARQ ACK/NACK feedback is determined as the HARQ ACK/NACK information for the PDSCH transmission. In other words, if the information of the number of transmission for certain time unit for which there is the HARQ ACK/NACK feedback represents the first transmission, the HARQ ACK/NACK feedback for this time unit is regarded as the HARQ ACK/NACK information for the PDSCH within this time unit.

If the PDSCH transmission for the received HARQ ACK/NACK feedback is not the first transmission, then in step S1840, the HARQ ACK/NACK information for the PDSCH transmission is determined according to the number of transmission of the PDSCH transmission and the channel information related to the PDSCH transmission, wherein, the channel information related to the PDSCH transmission includes at least one of an initial transmission rate of the PDSCH transmission, and a channel quality of the PDSCH transmission. Specifically, according to the HARQ ACK/NACK feedback corresponding to the information of the number of the PDSCH transmission, whether the HARQ feedback for the first transmission of the PDSCH is a HARQ ACK feedback or a HARQ NACK feedback is determined, and the determined HARQ ACK/NACK feedback for the first transmission of the PDSCH is determined as the HARQ ACK/NACK information for the PDSCH. In other words, if the information of the number of transmission for certain time unit (that is, certain historical time slot) for which there is the HARQ ACK/NACK feedback represents not the first transmission, whether the HARQ feedback is the HARQ ACK feedback or the HARQ NACK feedback when the PDSCH is assumed to be the first transmission for this time unit is determined.

Specifically, step S1840 may include determining a probability that the HARQ feedback for the first transmission of the PDSCH transmission is NACK, according to the number of transmission of the PDSCH transmission and the channel information related to the PDSCH transmission.

To sum up, when the number of PDSCH transmission for certain time unit (i.e., certain historical time slot) for which there is the HARQ ACK/NACK feedback represents the k-th transmission (wherein k is a positive integer greater than 1), in a case that it is assumed that the transmission for the PDSCH within this time unit is the first transmission and the first transmission adopts the same MCS (that is, the same bit rate) as that of the current k-th transmission, the probability that the HARQ feedback of the first transmission for this time unit is the HARQ NACK feedback, is determined.

Specifically, in one exemplary embodiment of the disclosure, a probability [symbol] that the HARQ feedback of the k-th transmission is the HARQ NACK feedback may be calculated by the following equation 1.

$$ℙ [ {\overline{𝒜}}_{k} ] = φ ( k , {R}_{f} ) = Q ( \frac{kC - {R}_{f}}{\sqrt{V / {n}^{′}}} ) = {\int }_{{x}_{k}}^{∞} \frac{1}{\sqrt{2 π}} {e}^{- {t}^{2} / 2} dt \qquad ( 1 )$$

wherein,

$${x}_{k} = \frac{kC - {R}_{f}}{\sqrt{V / {n}^{′}}} ; C = {{log}_{2} ( 1 + P )}_{f} {=}^{Δ} \frac{{log}_{2} ( M )}{{n}^{′}} 2 ( P + 2 ) / ( P + 1 ) \hat{} 2 ( log e ) \hat{} 2 ;$$

M denotes the M-th segment message set in a message set [symbol] :={1, 2, . . . , M}; the encoder maps a message to a codeword having a length of n. The selected codeword xⁿ is divided into L symbol blocks, each of length n′, i.e., xⁿ=(x⁽¹⁾, . . . , x^{(L)}, wherein x^{(k)}=(x_{n′(k-1)+1}, ***, x_{n′k}).

Based on this, assuming that [symbol] and R_{f}/k (that is, a target bit rate R) of the k-th HARQ is known, and R and SNR are unchanged in 1 to k rounds of the HARQ, the probability [symbol] that the first HARQ feedback is the NACK may be obtained by determining the SNR of the k-th HARQ, as shown in equation 2.

$$ℙ [ {\overline{𝒜}}_{1} ] = φ ( 1 , {R}_{f} ) = Q ( \frac{C - {R}_{f} / k}{\sqrt{V / {n}^{′}}} ) = {\int }_{{x}_{1}}^{∞} \frac{1}{\sqrt{2 π}} {e}^{- {t}^{2} / 2} dt \qquad ( 2 )$$

$$wherein {x}_{1} = \frac{C - {R}_{f} / k}{\sqrt{V / {n}^{′}}} .$$

The step S1840 may further include: determining the HARQ feedback for the first transmission of the PDSCH as the HARQ ACK feedback or HARQ NACK feedback, according to the probability [symbol] that the HARQ feedback for the first transmission of the PDSCH is the HARQ NACK feedback. In other words, according to the probability [symbol] that the HARQ feedback for the first transmission for this time unit (i.e., historical time slot) is HARQ NACK feedback, the HARQ feedback for the first transmission for this time unit is randomly generated to be the HARQ ACK feedback or the HARQ NACK feedback.

Specifically, if the probability [symbol] is greater than or equal to a threshold, the HARQ ACK/NACK information for the PDSCH transmission is determined as NACK, wherein the threshold may be a fixed value, or be a random number randomly generated within [0,1]. If the probability [symbol] is less than the threshold, the HARQ ACK/NACK information for the PDSCH transmission is determined as ACK. That is, when the PDSCH is not the first transmission for certain time unit, the disclosure calculates whether the HARQ feedback is the ACK feedback or the NACK feedback when assuming that the transmission for the PDSCH is the first transmission. FIG. 18C shows a result diagram of the HARQ feedback regarding the first transmission for each time unit (i.e., each historical time slot) within the first time unit determined by step S1830 according to an exemplary embodiment of the disclosure.

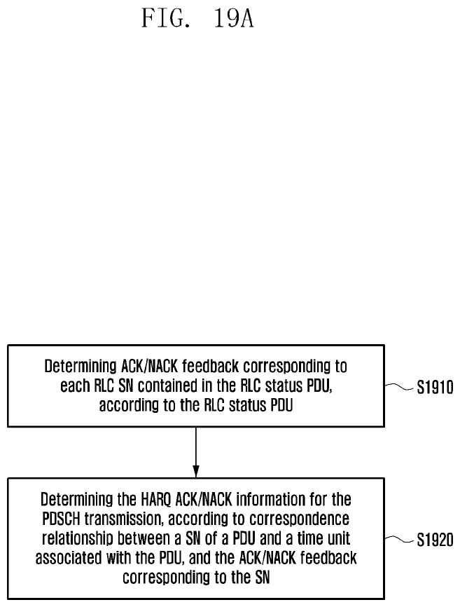

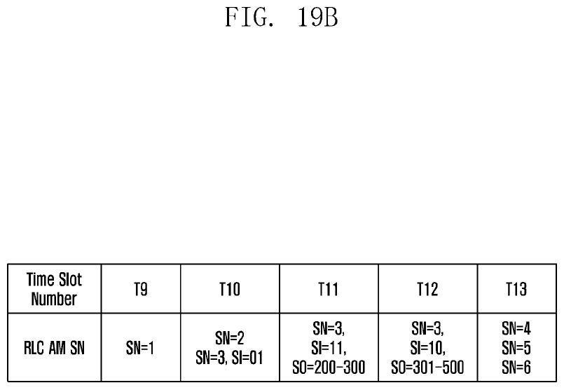

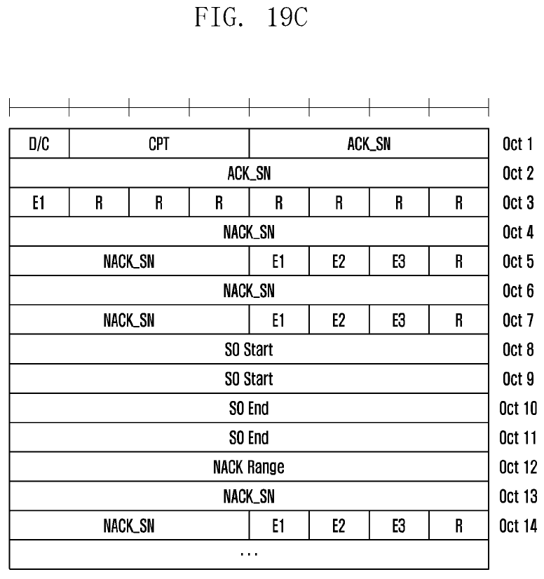

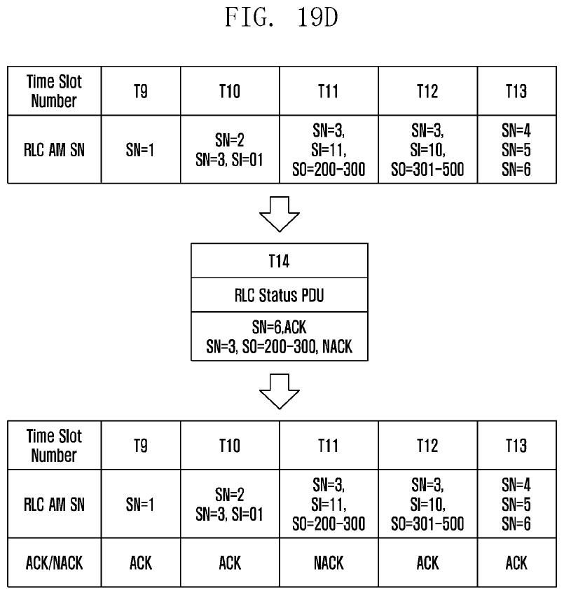

Referring back to FIG. 17A, at step S1720, in response to the absence of the HARQ ACK/NACK feedback received from the UE, the HARQ ACK/NACK information for the PDSCH is determined according to the RLC status PDU received from the UE. To sum up, for each time unit, for which there is no HARQ ACK/NACK feedback, among a plurality of time units (i.e., a plurality of historical time slots) within the first time unit, the ACK/NACK fed back according to the RLC status PDU is substituted for the HARQ ACK/NACK feedback. This is described below in details with reference to FIGS. 19A, 19B, 19C and 19D.

FIG. 19A is a flowchart showing a process of determining HARQ ACK/NACK information for a PDSCH according to a RLC status PDU according to an exemplary embodiment of the disclosure.

As shown in FIG. 19A, in step S1910, ACK/NACK feedback corresponding to each RLC SN contained in the RLC status PDU is determined, according to the RLC status PDU. For example, the network node may obtain the RLC status PDU (for example, a status report of a RLC layer) shown in FIG. 19C from the UE, and obtains ACK/NACK information corresponding to the RLC SN from this RLC status PDU.

In step S1920, the HARQ ACK/NACK information for the PDSCH transmission is determined, according to correspondence relationship between a SN of a PDU and a time unit associated with the PDU, and the ACK/NACK feedback corresponding to the SN. That is, whether each time unit (i.e., each historical slot) within the first time unit is correctly demodulated is determined. Wherein the correspondence relationship is determined based on a RLC data PDU and scheduling information of the PDSCH transmission. In addition, when there are segments in the RLC PDU, the correspondence relationship is also based on a segmentation offset (SO) of the RLC PDU. FIG. 19B shows a correspondence relationship between SN, SO of an RLC PDU and a plurality of time units (i.e., a plurality of historical time slots) in the first time unit according to one exemplary embodiment of the disclosure. FIG. 19D is a diagram showing a process of determining HARQ ACK/NACK information of each time unit (i.e., each historical time slot) according to ACK/NACK feedback corresponding to each RLC SN and correspondence relationship according to one exemplary embodiment of the disclosure. Referring to a table in the middle of FIG. 19D, the following information may be extracted from the RLC status PDU obtained in a time slot T14: a PDU having a SN less than or equal to 6 corresponds to ACK, wherein a PDU having a SN equal to 3 and SO ranging from 200 to 300 corresponds to NACK. Therefore, according to the information extracted from the RLC status PDU and the corresponding relationship represented in the table above in FIG. 19D, it can be determined whether each time unit (i.e., each historical time slot) is correctly demodulated, i.e., the ACK/NACK feedback information for the PDSCH for each time unit may be determined, as shown in the table below FIG. 19D.

The process of obtaining HARQ ACK/NACK information for the PDSCH is described by referring to FGS. 17A to 19D above. Based on this, the BLER information in the channel-related information may be obtained based on the HARQ ACK/NACK information for the PDSCH.

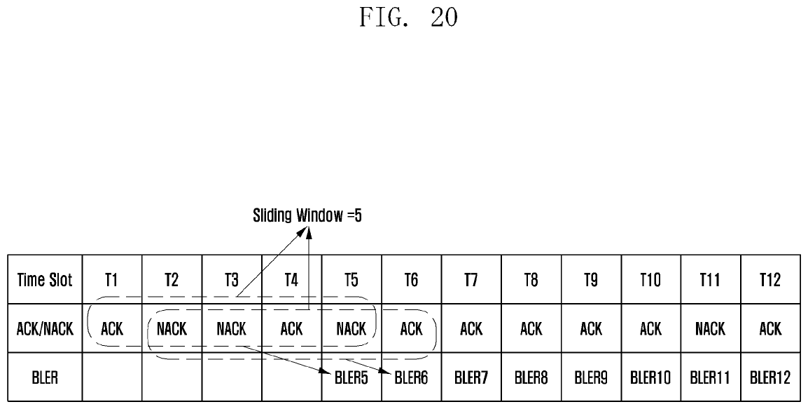

Specifically, by filtering the HARQ ACK/NACK information for the PDSCH transmission according to the specified window length, the BLER information in the channel-related information is obtained. For example, the BLER information for each time unit within the first time unit may be determined by a moving average filtering method, as shown in FIG. 20, it may assume that a size of the sliding window is 5, BLER information for each time unit (i.e., each historical slot) may be equal to the number of NACKs within the sliding window/the size of the sliding window. For example, BLER information for a historical time slot T5 may be equal to ⅗=60%, BLER information for a historical time slot T6 may be equal to ⅗=60%. In addition, as shown in FIG. 17B, the BLER processing module inputs the determined BLER information to an AI network (for example, LSTM-based first neural network) to predict the MCS and REP for the PDSCH.

In another exemplary embodiment of the disclosure, in a case that the HARQ ACK/NACK information for the PDSCH transmission includes the HARQ ACK/NACK feedback received from the user equipment, if the PDSCH transmission for the received HARQ ACK/NACK feedback is the first transmission, the received HARQ ACK/NACK feedback is determined as the HARQ ACK/NACK information for the PDSCH transmission, this is same as the process described above with reference to step S1830, so it will not be repeated here. Alternatively, if the PDSCH transmission for the received HARQ ACK/NACK feedback is not the first transmission and the received HARQ ACK/NACK feedback is NACK, the received HARQ ACK/NACK feedback is determined as the HARQ ACK/NACK information for the PDSCH transmission. That is, in this case, the received HARQ ACK/NACK feedback is directly determined as the HARQ ACK/NACK information for the PDSCH transmission. Alternatively, if the PDSCH transmission for the received HARQ ACK/NACK feedback is not the first transmission and the received HARQ ACK/NACK feedback is ACK, the HARQ ACK/NACK information for the PDSCH transmission is determined, according to the number of transmission of the PDSCH transmission and channel information related to the PDSCH transmission, this is same as the process described above with reference to step S1840, so it will not be repeated here.

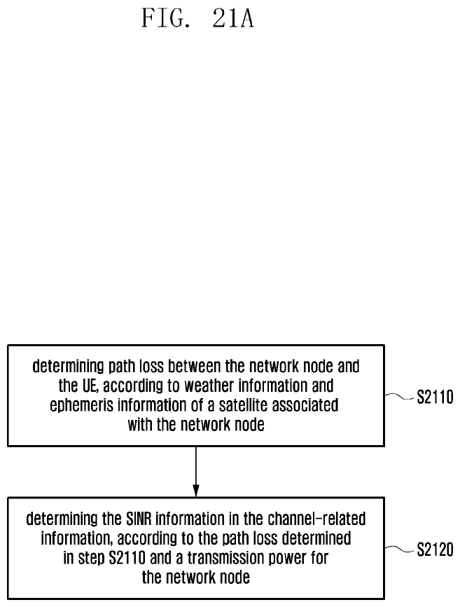

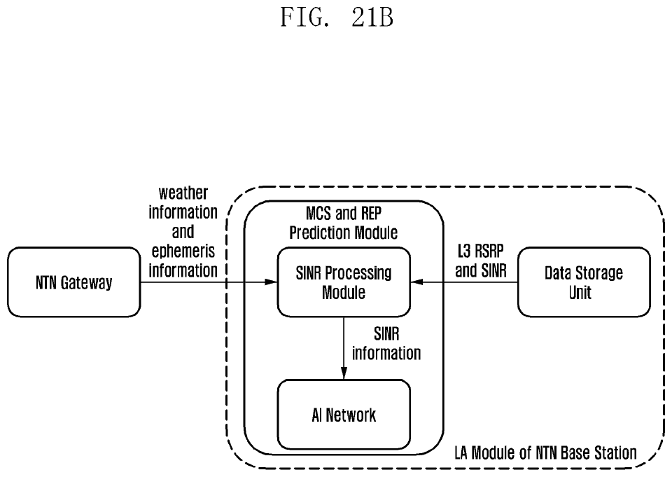

FIG. 21A is a flowchart showing a process of obtaining SINR information in channel-related information according to another exemplary embodiment of the disclosure. FIG. 21B is a schematic diagram showing a process of obtaining SINR information according to an exemplary embodiment of the disclosure.

In step S2110, path loss between the network node and the UE is determined, according to weather information and/or ephemeris information of a satellite associated with the network node. In the process diagram as shown in FIG. 21B, a SINR processing module in a MCS and REP prediction module determines the path loss between the network node and the UE according to weather information and ephemeris information from an NTN gateway. In addition, in another embodiment, the weather information and the ephemeris information from the NTN gateway may be stored in data storage unit in a LA module in an NTN base station, and the SINR processing module obtains the weather information and the ephemeris information from the data storage unit. In the exemplary embodiment of the disclosure, the path loss PL between the network node and UE is determined according to the following equation 3.

$$PL = {PL}_{b} + {PL}_{g} + {PL}_{s} + {PL}_{e} \qquad ( 3 )$$

Here, PL_{b} denotes first path loss (also known as basic path loss) between the network node and the UE, in units of dB; PL_{g} denotes attenuation associated with air density, i.e., weather correction value, in the disclosure may be referred to as a first loss correction value, in units of dB; PLₛ denotes attenuation caused by ionosphere or troposphere scintillation, i.e., the sum of a pressure correction value related to atmospheric pressure and a humidity correction value related to air humidity, in the disclosure, the pressure correction value may be referred to as a second loss correction value, and the humidity correction value may be referred to as a third loss correction value, in units of dB; PLe denotes building entrance loss, in units of dB, and it is negligible in the NTN scenario. The process of determination of first path loss PL_{b}, the first loss correction value PL_{g}, a sum PLₛ of the second loss correction value and the third loss correction value are described in detail.

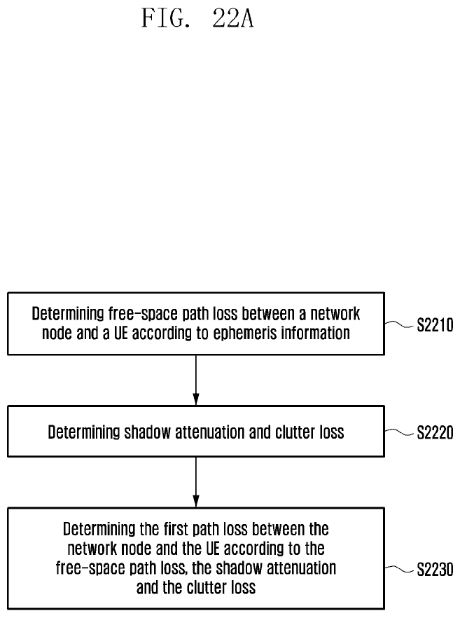

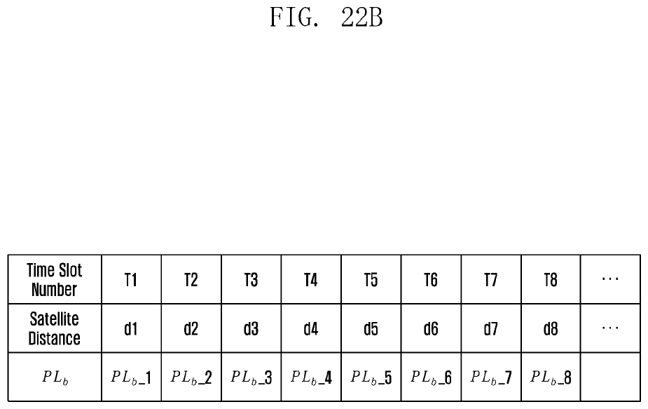

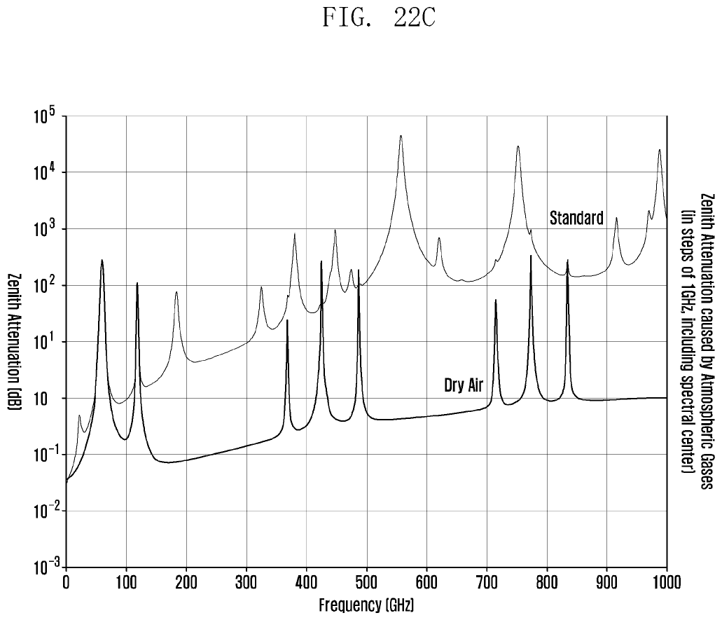

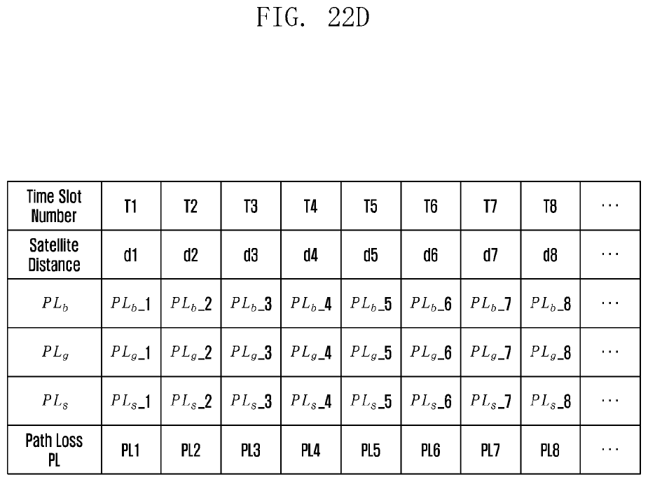

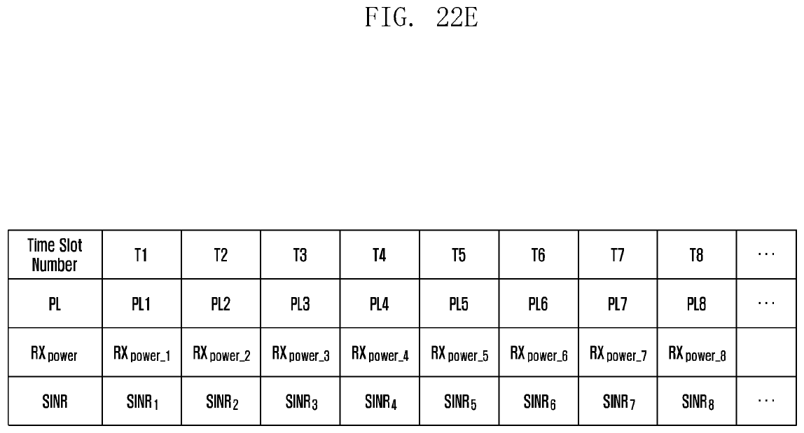

In one exemplary embodiment of the disclosure, first path loss between the network node and the UE is determined according to the ephemeris information of the satellite. This is described below in detail with reference to FIGS. 22A and 22B.

FIG. 22A is a flowchart showing a process of determining first path loss between a network node and a UE according to ephemeris information according to an exemplary embodiment of the disclosure.

As shown in FIG. 22A, in step S2210, free-space path loss between a network node and a UE is determined according to the ephemeris information.

Specifically, firstly, the network node may obtain the ephemeris information from an NTN gateway, and determine a position of a satellite associated with the network node based on the obtained ephemeris information. In the disclosure, height of the satellite and an elevation angle between the UE and the satellite may be used to represent the position of the satellite at each time slot, that is, the position of the satellite relative to the UE at each time slot.

Then, a distance between the satellite and the UE is determined according to the location of the satellite, wherein the distance is also known as a slant range. For example, the distance d between the satellite and UE at each historical time slot may be determined based on equation 4, in units of meter (m):

$$d = \sqrt{{R}_{E}^{2} {sin}^{2} α + {h}_{0}^{2} + 2 {h}_{0} + {R}_{E}} - {R}_{E} sin α n ,$$

RE represents a radius of the Earth, α represents the elevation Angle between the UE and the satellite, and h₀ represents the height of the satellite.

Thereafter, the free-space path loss between the satellite and the UE (that is, the free-space path loss between the satellite and the UE for each historical time slot) is determined according to the distance between the satellite and the UE. For example, the free-space path loss FSPL (d,f_{c}) (which is in units of GHz) between the satellite and the UE corresponding to the distance d (which is in units of meter (m)) and a frequency f_{c} (which is in units of dB) is determined according to the following equation 5, wherein f_{c} denotes a center frequency point of the current frequency range.

FSPL (d, f_{c})=32.45+20 log₁₀ (f_{c})+20 log₁₀(d) tep S2220, shadow attenuation and clutter loss is determined.

Specifically, in one exemplary embodiment of the disclosure, the shadow attenuation may be represented by a random number generated by a normal distribution, that is, the shadow attenuation SF may follow the normal distribution

$$SF ∼ N ( 0 , {σ}_{SF}^{2} ) .$$

In the disclosure, CL(α, f_{c}) may be used to represent the clutter loss, and when the UE in a Line of Sight (LOS) scenario, the clutter loss may be neglected.

In step S2230, the first path loss between the network node and the UE is determined according to the free-space path loss, the shadow attenuation and the clutter loss. In particular, the first path loss may be determined according to the equation 6.

$${PL}_{b} = FSPL ( d , {f}_{c} ) + SF + CL ( α , {f}_{c} ) \qquad ( 6 )$$

According to the above Math FIG. 4 and that the clutter loss CL (α, f_{c}) is negligible in the LOS scenario, the equation 6 may become equation e 7:

$${PL}_{b} = 32.45 + 20 {log}_{10} ( {f}_{c} ) + 20 {log}_{10} ( \sqrt{{R}_{E}^{2} {sin}^{2} α + {h}_{0}^{2} + 2 {h}_{0} + {R}_{E}} - {R}_{E} sin α ) + SF 0 , σ\_SF \hat{} 2 ) .$$

FIG. 22B shows one example of basic path loss PL_{b} determined according to ephemeris information for a plurality of time slots (e.g., T1, T2, T3 . . . ).

The process of determining the first path loss is described above, and a process of determining the first loss correction value, the second loss correction value and the third loss correction value is described below. Generally speaking, in an exemplary embodiment of the disclosure, at least one of the first loss correction value related to air density, the second loss correction value related to atmospheric pressure, and the third loss correction value related to air humidity is determined according to the weather information. Specifically, the network node may obtain the weather information within the coverage range of network node from the NTN gateway, including information for example rain and fog, as well as information of humidity of the air, temperature, and pressure, and so on.

Specifically, the first loss correction value is determined according to zenith attenuation and a satellite elevation angle between the user equipment and the satellite. That is, according to the zenith attenuation due to air density and the satellite elevation angle between the UE and the satellite, the first loss correction value related to air density is determined for each historical time slot. For example, the attenuation (i.e., the first loss correction value) related to air density for frequency f may be determined by the following equation 8, wherein the frequency f is in units of GHz.

$${PL}_{g} = \frac{{A}_{zenith} ( f )}{sin α} )$$

wherein, A_{zenith} (f_{c}) denotes the corresponding zenith attenuation corresponding to a frequency f_{c}, for example, FIG. 22C shows the corresponding zenith attenuation A_{zenith} (f) for frequencies between 1 and 350 GHz of ITU R P.676.

In addition, for system level simulations under 6 GHz, for latitudes within a range of −20° to +20°, PLₛ which is the sum of the second loss correction value related to atmospheric pressure and the third loss correction value related to air humidity may be determined according to the following equation 9, wherein PLₛ is equal to A_{IS}. For latitudes within the range of +20° to +60° and −20° to −60°, PLₛ=0.

$${A}_{IS} = {P}_{fluc} / \sqrt{2} . \qquad ( 9 )$$

wherein P_{fluc} denotes peak amplitude fluctuation which provides statistical data on scintillation occurring along an equatorial ionospheric path, and which can be obtained according to the relevant provision of the 3GPP protocol.

After the first path loss, the first loss correction value, the second loss correction value and third loss correction value are determined, according to the first path loss and at least one of the first loss correction value, the second loss correction value and third loss correction value, second path loss between UE and the network node is determined. That is, for each historical time slot, by adding the results of the above Math FIGS. 7, 8, and 9, the path loss PL (i.t., the second path loss) between the network node and UE for each historical time slot may be obtained. FIG. 22D shows one example of path loss PL determined for a plurality of historical time slots (e.g., T1, T2, T3 . . . ) according to an exemplary embodiment of the disclosure.

Return reference to FIG. 21A, in step S2120, the SINR information in the channel-related information is determined, according to the path loss determined in the step S2110 and a transmission power for the network node.

Specifically, firstly, a signal received power of the UE (that is, the signal received power of the UE at each time unit (that is, each historical time slot)) is estimated according to the path loss and the transmission power for the network node. For example, the signal received power Rx_{power} of the UE at each time unit (i.e., historical time slot) may be determined according to the equation 10.

$${Rx}_{power , dB} = {Tx}_{power , dB} - PL . \qquad ( 10 )$$

wherein, Tx_{power} denotes the signal received power of the UE at each time unit, and the network node may receive the signal received power for each time unit from the UE. This signal received power may be a RSRP calculated by the UE based on a reference signal transmitted by the network node.

Then, the SINR information is determined according to the estimated signal received power and signal noise. That is, the SINR information at each time unit is determined based on signal noise and the estimated signal received power of the UE at each time unit.

In one exemplary embodiment of the disclosure, the SINR information at each time unit may be determined according to equation 11.

$$SNR = \frac{{Rx}_{power}}{{σ}_{N}^{2}} \qquad ( 11 )$$

wherein

$${σ}_{N}^{2}$$

is noise. The SINR information for each time unit may be determined as the SNR wherein determined using the above equation 11. For example, FIG. 22E shows SINR information for each time slot determined according to signal noise and signal received power of a UE at each time slot (i.e., T1, T2, T3 . . . ) according to an exemplary embodiment of the disclosure.

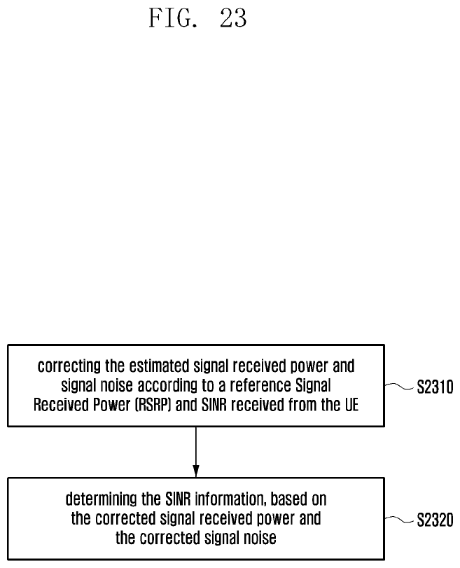

In another illustrative embodiment of the disclosure, signal noise and the estimated signal received power of the UE at each time unit (that is, each historical time slot) may be corrected, and then, the corrected signal received power and signal noise are used to determine the SINR information for each time unit, that is, the corrected SINR information for each time unit. This is described in detail below with reference to FIG. 23.

FIG. 23 is a flowchart showing a process of determining SINR information according to signal noise and estimated signal received power of a UE according to one exemplary embodiment of the disclosure.

As shown in FIG. 23, in step S2310, the estimated signal received power and the signal noise are corrected according to the reference signal received power RSRP and SINR received from the UE (that is, L3 RSRP and SINR obtained from the data storage unit by the SINR processing module shown in FIG. 21B).

Firstly, the power correction value and the noise correction value are determined. Specifically, assuming that the network node receives RSRP and SINR from the UE at a historical time slot T3, i.e., RSRP (denoted as RSRP₃₋₁) and SINR (denoted as SINR₃₋₁) of Layer 3 (L3), and the estimated signal received power and the signal noise for the historical time slot T3 are RSRP3 and

$${σ}_{N}^{2} ,$$

respectively, umen une power correction value ΔRx_{power} and the noise correction value

$$Δ {σ}_{N}^{2}$$

may be determined according to RSRP₃₋₁, SINR₃₋₁, R_{xpower3} and

$${σ}_{N}^{2} .$$

For example, the power correction value ΔRx_{power} and the noise correction value Δσ_{N9}² may be determined according to the following equations 12 and 13.

$$Δ {Rx}_{power} = {RSRP}_{3 - 1} - {Rx}_{power 3} \qquad ( 12 )$$

$$Δ {σ}_{N}^{2} = \frac{RSRP 3 - 1}{SINR 3 - 1} - {σ}_{N}^{2} \qquad ( 13 )$$

Then, the estimated signal received power and the signal noise are corrected based on the power correction value and the noise correction value, respectively.

Specifically, after determining the power correction value ΔRx_{power} and the noise correction value

$$Δ {σ}_{N}^{2} ,$$

the estimated signal received power and the signal noise at each historical time slot after the historical time slot T3 may be corrected by using the power correction value ΔRx_{power} and the noise correction value

$$Δ {σ}_{N}^{2} .$$

For example, the estimated signal received power Rx_{power} at each historical time slot after the historical time slot T3 may be added to the power correction value ΔRx_{power}, and the corresponding signal noise is added to the noise correction value

$$Δ {σ}_{N}^{2} ,$$

so as to obtain unie corrected signal received power and the corrected signal noise for each historical time slot after the historical time slot T3.

In step S2320, the SINR information is determined based on the corrected signal received power and the corrected signal noise.

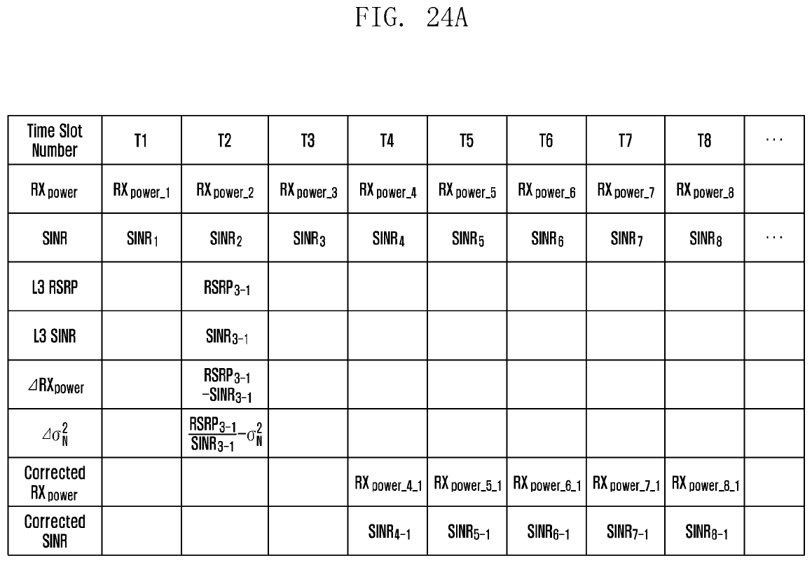

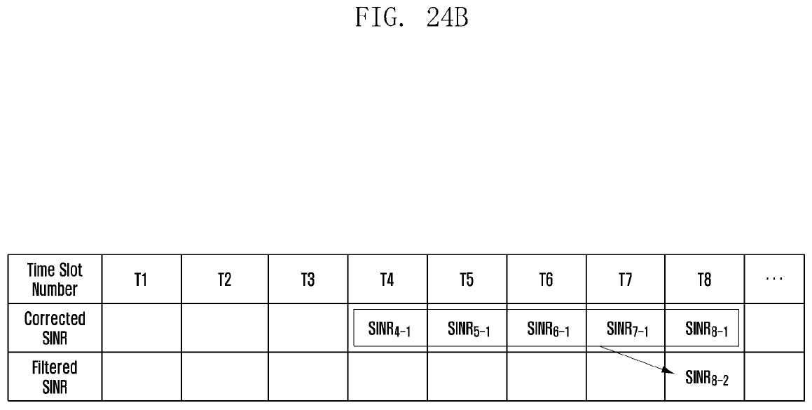

Specifically, according to the above equation 11, the corrected signal received power and the corrected signal noise may be used to calculate the SINR information for each historical time slot after the historical time slot T3, that is, the corrected SINR information. For example, FIG. 24A shows an example of the corrected SINR information determined according to the corrected signal received power and the corrected signal noise for each historical time slot.

In addition, in another exemplary embodiment of the disclosure, the method shown in FIG. 23 may further include performing filtering on a plurality of pieces of the corrected SINR information to determine the SINR information in the channel-related information. For example, by performing filtering on the plurality of pieces of the corrected SINR information for a plurality of historical time slots according to the specified window length, the filtered SINR information for each historical time slot is determined.

For example, as shown in FIG. 24B, the filtered SINR information for each historical time slot may be determined by the sliding average filtering method. Assuming that the specified window length may be 5, the filtered SINR information for each historical time slot may be equal to the average value of the respective values within the sliding window. For example, the filtered SINR information for historical time slot T8 may be the average value of the corrected SINRs for historical time slots T4, T5, T6, T7, and T8. However, this is only an example. The disclosure may also use other filtering methods to filter a plurality of pieces of the corrected SINR information for a plurality of historical time slots. By using the method of determining SINR information provided in the disclosure, more accurate SINR information may be obtained.

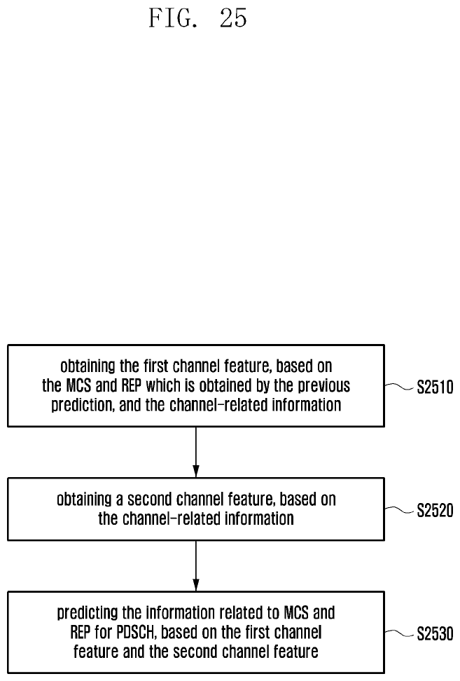

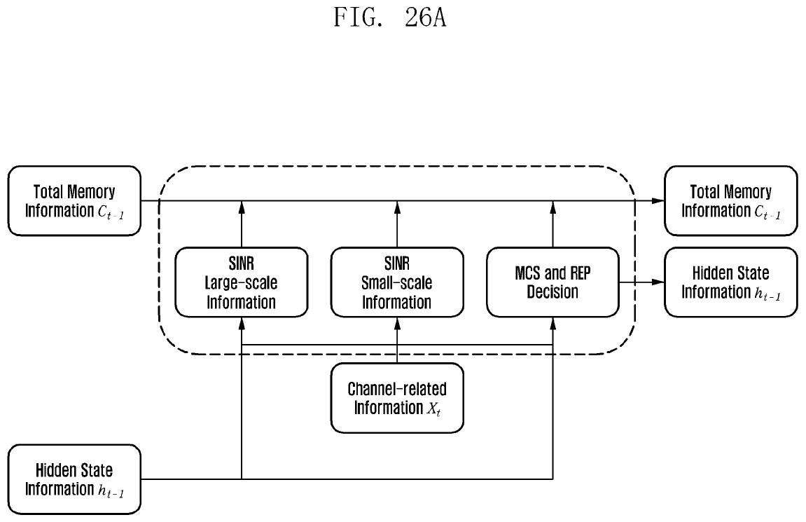

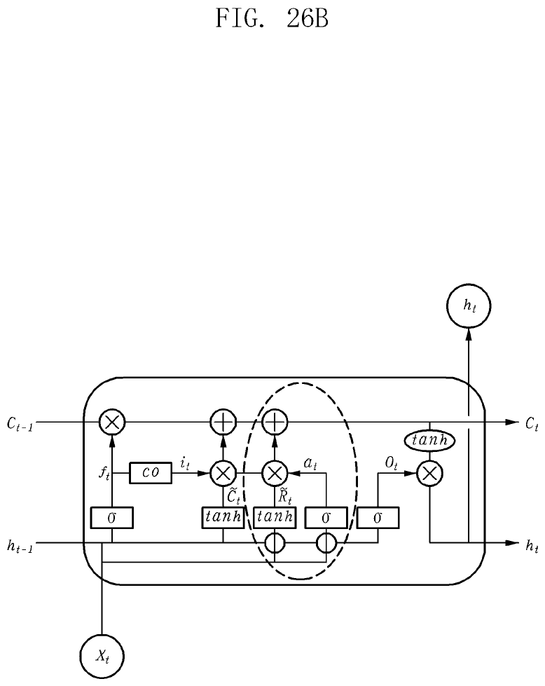

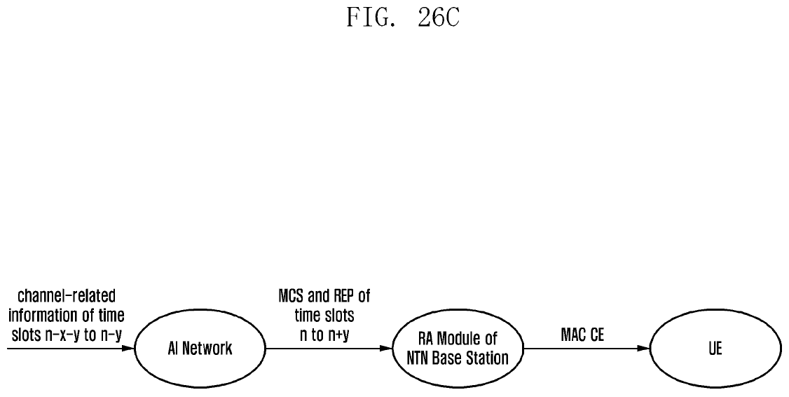

Return reference to FIG. 15A, in step S1520, information related to modulation and coding scheme (MCS) and repetition number (REP) for PDSCH is predicted, based on the channel-related information, through an AI network. As shown in FIG. 15B, the AI network (i.e., a LSTM-based first neural network) predict the information related to MCS and REP for the PDSCH, based on the BLER information obtained from the BLER processing module, the SINR information obtained from the SINR processing module as well as the CQI information, the MCS information and the REP information obtained from the CQI, MCS and REP processing module. This is described below in detail with reference to FIGS. 25, 26A, and 26B.

FIG. 25 is a flowchart showing a process of predicting information related to MCS and REP for PDSCH based on channel-related information through an AI network according to an exemplary embodiment of the disclosure.

As shown in FIGS. 26A and 26B, the disclosure adds a new outer loop rate control (ORLC) input gate and an ORLC memory unit into the LSTM, wherein the ORLC memory unit is only used to save feature information of a current time slot (for example, a historical time slot t), thereby avoiding interference from historical hidden state information. In addition, due to the addition of the ORLC input gate, the feature information of the current time slot may be extracted only by input information for the current time slot, to obtain SINR small-scale information for the current time slot. In addition, SINR large-scale information for the current time slot may be obtained by using an original input gate and a memory unit in a LSTM, based on the input information for the current time slot and the hidden state information for a previous time slot. On this basis, total memory information for the current time slot may be obtained, by combining historical SINR large-scale information and historical SINR small-scale information, as well as the SINR large-scale information and the SINR small-scale information for the current time slot, and finally, the MCS and REP for a future time slot may be obtained. The first neural network model provided in the disclosure is simple, its computational cost is small, and may simultaneously obtain the SINR large-scale information and the SINR small-scale information, and it may predict the optimal MCS and REP of PDSCH while reducing the cost of the NTN base station. This is described below in detail.

In step S2510, the first channel feature is obtained, based on the MCS and REP which are obtained by the previous prediction, and the channel-related information.

Specifically, a first feature vector is obtained based on the MCS and REP which are obtained by the previous prediction and the channel-related information, through a first sigmoid neural network layer in the AI network. As shown in FIG. 26B, the channel-related information may be expressed as Xt, the MCS and REP which are obtained by the previous prediction may be expressed as ht-1, in the disclosure, the MCS and REP which are obtained by the previous prediction may also be referred to as hidden state information ht-1. As shown in FIG. 26B, by inputting the result of concatenating the channel-related information Xt and the hidden state information ht-1 into the first sigmoid neural network layer o (also known as a sigmoid activation function) for processing, the first feature vector fₜ is obtained, wherein the first feature vector fₜ may also be referred to as the t-time slot forget gate.

Then, a second feature vector is obtained based on the MCS and/or REP which is obtained by the previous prediction and the channel-related information, through a first tanh neural network layer in the AI network. As shown in FIG. 26B, by inputting the result of concatenating the channel-related information Xₜ and the hidden state information hₜ₋₁ into the first tanh neural network layer for processing, the second feature vector \tilde{C}ₜ is obtained, wherein the second feature vector \tilde{C}ₜ may also be referred to as a t-time slot candidate memory unit.

Thereafter, a third feature vector is obtained by transforming the first feature vector. As shown in FIG. 26B, by performing a co operation on the first feature vector fₜ (wherein co(fₜ)=1−fₜ), the third feature vector it is obtained, wherein the third feature vector it may also be referred to as a t-time slot input gate.

Then, the first channel feature is obtained, based on the first feature vector, the second feature vector and the third feature vector. As shown in FIG. 26B, by multiplying total memory information Cₜ₋₁ point by point with the first feature vector fₜ, an eighth feature vector is obtained. In other words, the first feature vector fₜ (i.e., a forget gate) is used to forget some information in the total memory information Cₜ₋₁, thereby obtaining the eighth feature vector. By multiplying the third feature vector it point by point with the second feature vector Čₜ, a ninth feature vector is obtained. In the disclosure, the ninth feature vector may be referred to as SINR large-scale information for the time slot t, that is, the third feature vector it may be used to extract feature information in the second feature vector Ct. Thereafter, the first channel feature is obtained by adding the eighth feature vector and the ninth feature vector.

In step S2520, a second channel feature is obtained based on the channel-related information. In the disclosure, the second channel feature may be referred to as SINR small-scale information, as shown in FIG. 26A.

First, a fourth feature vector is obtained based on the channel-related information, through a second sigmoid neural network layer in the AI network. By referring to FIG. 26B, by inputting the channel-related information Xₜ into the second sigmoid neural network layer σ for processing, the fourth feature vector αₜ is obtained, wherein the fourth feature vector αₜ may also be referred to as the t-time slot ORLC input gate, that is, the ORLC input gate newly added into the LSTM in the disclosure, and this t-time slot ORLC input gate is only determined by feature information of a current time slot (i.e., a historical time slot t). In the exemplary embodiment of the disclosure, the fourth feature vector αₜ may be determined by the following equation 14.

$${α}_{t} = σ ( {X}_{t} {W}_{{X}_{α}} + {b}_{α} ) \qquad ( 14 )$$

wherein, Wₓ_{_{α}} denotes a weighting matrix used for transferring the channel-related information Xₜ to αₜ, and b_{α} denotes an offset parameter used for obtaining αₜ.

Then, a fifth feature vector is obtained based on the channel-related information, through a second tanh neural network layer in the AI network. As shown in FIG. 26B, by inputting the channel-related information Xₜ into the second tanh neural network layer for processing, the fifth feature vector \tilde{R}ₜ is obtained, wherein the fifth feature vector \tilde{R}ₜ may also be referred to as a t-time slot candidate ORLC memory unit, that is, the ORLC memory unit newly added into the LSTM in the disclosure, and this t-time slot candidate ORLC memory unit only saves the feature information of the current time slot (i.e., the historical time slot t), thereby avoiding interference from historical hidden state information. In the exemplary embodiment of the disclosure, the fifth feature vector \tilde{R}ₜ may be determined by the equation 15:

$${\tilde{R}}_{t} = tanh ( {X}_{t} {W}_{{X}_{\tilde{R}}} + {b}_{\tilde{R}} ) \qquad ( 15 )$$

wherein W_{X}_{_{\tilde{R}}} denotes a weighting matrix used for transferring the channel-related information Xₜ to \tilde{R}ₜ, and b_{\tilde{R}} denotes an offset parameter used for obtaining Rₜ.

Thereafter, the second channel feature is obtained based on the fourth feature vector and the fifth feature vector. As shown in FIG. 26B, by multiplying the fourth feature vector at point by point with the fifth feature vector \tilde{R}ₜ, the second channel feature (that is, SINR small-scale information for the historical time slot t) is obtained. In other words, the feature information in the fifth feature vector \tilde{R}ₜ is extracted by using the fourth feature vector αₜ, thereby obtaining SINR small-scale information.

In step S2530, the information related to the MCS and REP for the PDSCH is predicted, based on the first channel feature and the second channel feature.

First, by referring to FIG. 26B, the third channel feature Ct is obtained by adding the first channel feature and the second channel feature. In an exemplary embodiment of the disclosure, the third channel feature Cₜ may be determined by using the following equation 16.

$${C}_{t} = {f}_{t} θ {C}_{t - 1} + {i}_{t} θ {\tilde{C}}_{t} + {α}_{t} θ {\tilde{R}}_{t} \qquad ( 16 )$$

Then, the information related to MCS and REP for PDSCH is predicted based on the third channel feature.

Specifically, a sixth feature vector is obtained based on the MCS and REP which are obtained by the previous prediction and the channel-related information, through a third sigmoid neural network layer in the AI network. As shown in FIG. 26B, by inputting the result of concatenating the channel-related information Xₜ and the MCS and REP (i.e., hₜ₋₁) which are obtained by the previous prediction into the third sigmoid neural network layer, the sixth feature vector Oₜ is obtained. The sixth feature vector Oₜ may also be referred to as a t-time slot output gate, which is used to extract partial data of the total memory information Cₜ up to the historical time slot t. Then, a seventh feature vector is obtained based on the third channel feature, through a third tanh neural network layer in the AI network. As shown in FIG. 26B, by inputting the third channel feature Cₜ (that is, the total memory information Cₜ up to the historical time slot t) into the third tanh neural network layer for processing, the seventh feature vector tanh (Cₜ) is obtained. Then, the information related to MCS and/or REP for PDSCH is obtained, by processing the sixth feature vector and the seventh feature vector. As shown in FIG. 26B, by multiplying the seventh feature vector tanh (Cₜ) point by point with the sixth feature vector Oₜ, the hidden state information hₜ is obtained, wherein, the hidden state information hₜ includes the information related to the MCS and REP for the PDSCH, that is, the MCS and REP for the future time slot corresponding to the historical time slot t. In an exemplary embodiment of the disclosure, the hidden state information hₜ may be determined by the equation 17.

$${h}_{t} = {O}_{t} θ tanh ( {C}_{t} ) \qquad ( 17 )$$

In one exemplary embodiment of the disclosure, a time slot difference between the future time slot corresponding to the historical time slot t and the historical time slot t corresponds to the sum of: a transmission delay between the network node and the UE, and the prediction window length of the LSTM-based first neural network. For example, it assumes that the transmission delay between the network node and the UE is x time slots, and the prediction window length of the LSTM-based first neural network is y, the time slot difference between the future time slot corresponding to the historical time slot t and the historical time slot t may be x+y, that is, channel information of the historical time slot t may be used to predict MCS and REP for a future time slot t+x+y. In other words, as shown in FIG. 26C, the channel information from a historical time slot n−x−y to a historical time slot n−x may be used to predict the MCS and REP from a time slot n to a time slot n+y through the LSTM-based first neural network, and then the predicted MCS and REP are transmitted by the network node (for example, by a RA module of the NTN base station via a MAC CE to be described later), to the UE.

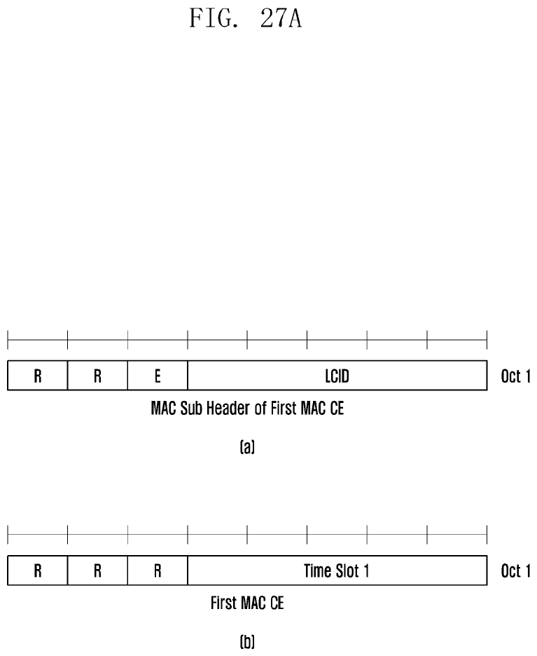

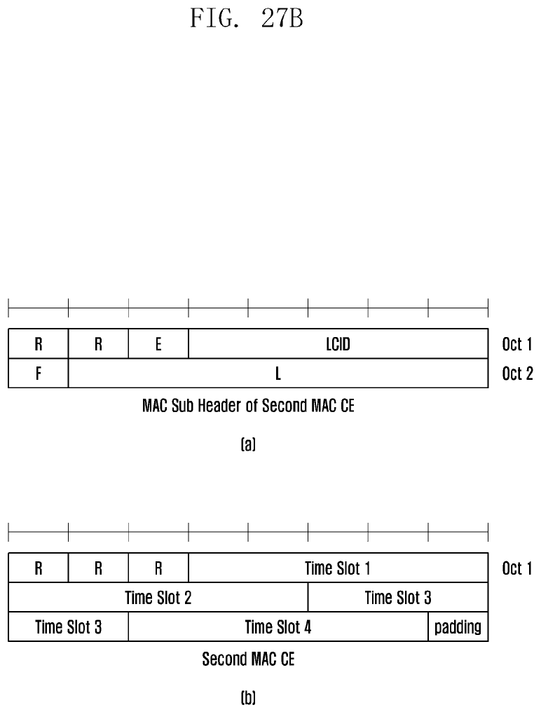

FIGS. 27 to 30 illustrate the transmission and reception of repetition number (REP) and modulation and coding scheme (MCS) information between a network node and a user equipment (UE).

Return referring to FIG. 15A, in step S1530, the predicted information related to MCS and REP is transmitted to the UE. As shown in FIG. 15B, the predicted MCS and REP are transmitted by the RA module of the NTN base station to the UE. In addition, the RA module of the NTN base station also transmits the predicted MCS and REP as well as the corresponding RLC status PDU to a data storage unit of the NTN base station, for predicting the MCS and REP for subsequent time slots.

Specifically, the transmitting the predicted information related to MCS and REP to the UE may include: transmitting the predicted information related to REP to the UE, through one of a first MAC CE and a second MAC CE; transmitting the predicted information related to the MCS to the UE through a DCI.

In one exemplary embodiment of the disclosure, the network node may transmit the predicted information related to REP to the UE through the first MAC CE, wherein the first MAC CE is used to indicate the repetition number of a PDSCH for one time slot. The disclosure indicates the first MAC CE by defining a new logical channel identifier (LCID), for example, as shown in Table 3 below, wherein Index denotes LCID.

TABLE 3

| Index | |
|---|---|
| 11001 | MAC CE is used to indicate a repetition number of a PDSCH for |
| | one time slot |

As shown in FIG. 27A, 5 bits in a MAC sub header corresponding to the first MAC CE are used to store the LCID corresponding to the first MAC CE. The first MCE CE includes only one field for indicating the repetition number of the PDSCH for one time slot. In one exemplary implementation, this field includes 5 bits, which can be used to indicate up to 32 repetition numbers.

In another exemplary embodiment of the disclosure, the network node may transmit the predicted information related to REP to the UE through a second MAC CE, wherein the second MAC CE is used to indicate the repetition numbers of the PDSCH for a plurality of time slots. The disclosure indicates the second MAC CE by defining a new LCID, for example, as shown in Table 4 below, wherein Index denotes the LCID.

TABLE 4

| Index | |
|---|---|
| 11010 | MAC CE is used to indicate a repetition |
| | number of a PDSCH for a plurality of time |
| | slots |

As shown in FIG. 27B, 5 bits in a MAC sub header corresponding to the second MAC CE are used to store the LCID corresponding to the second MAC CE, the length (in bytes) of the second MAC CE is indicated by a length field L in this MAC sub header, and the second MAC CE includes a plurality of fields to indicate the REP for each of the plurality of time slots, respectively. For example, in FIG. 27B, the second MAC CE may include four fields to indicate the REP for four time slots, i.e., the first field for the REP for time slot 1, the second field for the REP for time slot 2, the third field for the REP for time slot 3, and the fourth field for the REP for time slot 4. In one exemplary embodiment, each field for indicating the REP for a time slot in the second MAC CE includes 5 bits, therefore, each field may indicate up to 32 repetition numbers.

As shown in FIG. 15B, after the UE performs the communication operation with the NTN base station using the MCS and REP obtained from the RA module of the NTN base station, the CQI, HARQ feedback, RLC status PDU, L3 RSRP and L3 SINR obtained in the communication operation are uploaded to the NTN base station. The NTN base station stores the received information in the data storage unit of the NTN base station, for predicting the MCS and REP for subsequent time slots.

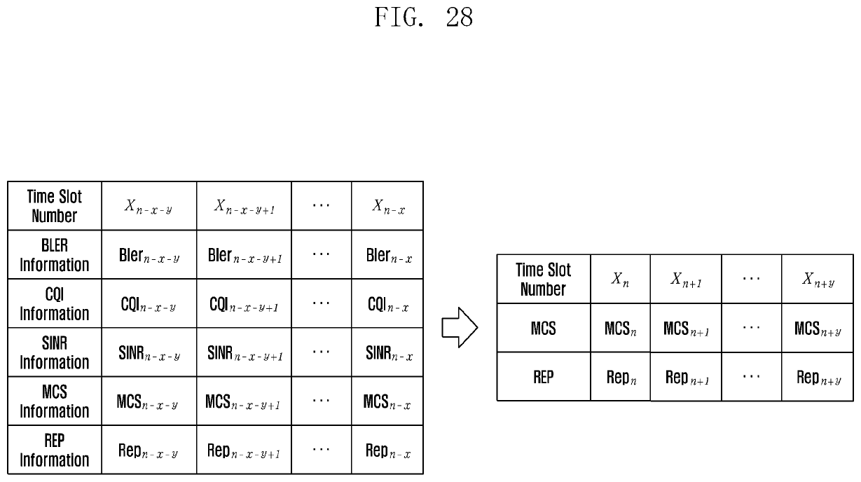

The method performed by the network nodes is described in FIG. 15A to FIG. 27B above, wherein this method, by inputting the calculated BLER information, CQI information, MCS information, REP information and SINR information into the AI network (i.e., the LSTM-based first neural network), may simultaneously extract SINR large-scale information and SINR small-scale information, thus, the optimal downlink scheduling MCS and REP for a plurality of future time slots may be predicted more accurately. For example, when the optimal downlink scheduling MCS and REP for a plurality of future time slots Xₙ to X_{n+y} is determined, firstly, the channel information (i.e., SINR information, CQI information, BLER information, MCS information and REP information) of each historical time slot in the historical time slots X_{n-x-y} to Xₙ₋ₓ is obtained according to the above step S1510, wherein x is a transmission delay (in units of a time slot) between the NTN base station and the NTN UE, y is a prediction window length (in units of a time slot) the LSTM-based first neural network, as shown in FIG. 28; then, the channel information of the historical time slots X_{n-x-y} to Xₙ₋ₓ is input into the first neural network in a chronological order, so as to predict the optimal scheduling MCS and REP for each of the future time slots Xₙ to X_{n+y}. For example, as shown in the following equation 18, the optimal scheduling MCS (i.e., MCSₙ) and REP (i.e., Repₙ) for the time slot Xₙ may be obtained.

$$( {MCS}_{n : n + y - 1} , {Rep}_{n : n + y - 1} ) = {Optimum {tput}_{y}}_{( {MCS}_{i} , {Rep}_{i} )} ( \begin{matrix}{BLER}_{n - x - y : n - x} , {CQI}_{n - x - y : n - x ,} \\ {SINR}_{n - x - y : n - x} , ( {MCS}_{n - x - y : n - x} , {Rep}_{n - x - y : n - x} )\end{matrix} ) \qquad ( 18 )$$

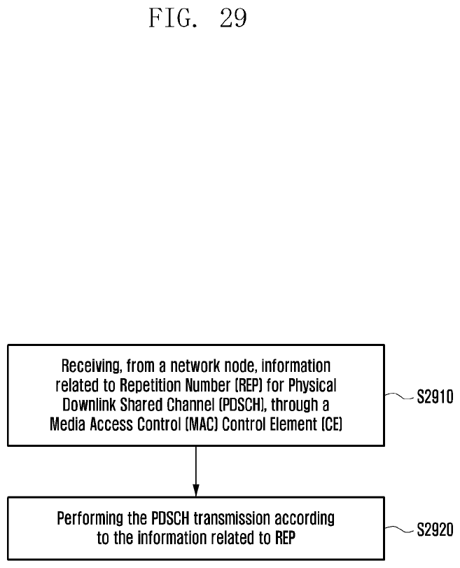

FIG. 29 is a flowchart showing a method performed by a UE according to an exemplary embodiment of the disclosure.

As shown in FIG. 29, in step S2910, information related to repetition number (REP) for physical downlink shared channel (PDSCH) is received, from a network node, through a media access control (MAC) control element (CE). In step S2920, the PDSCH transmission is performed according to the information related to REP. The information related to REP is received through the first MAC CE or the second MAC CE, wherein the first MAC CE is used to indicate the repetition number of PDSCH for one time slot, the second MAC CE is used to indicate the repetition number of PDSCH for a plurality of time slots. The first MAC CE and the second MAC CE are identified using a logical channel identifier (LCID) in a MAC sub header. The first MAC CE includes one field for indicating the REP of the PDSCH for one time slot, the length of the second MAC CE is indicated by the length field in the corresponding MAC sub header, and the second MAC CE includes a plurality of fields for indicating the REP for each of the plurality of time slots, respectively. Since the structures of the first and second MAC CEs have been described above with reference to FIGS. 27A and 27B, they will not be repeated here.

In one exemplary embodiment of the disclosure, the method may further include: receiving a radio resource control (RRC) signaling from a network node; wherein, the information related to REP is received through the MAC CE if there is no first information in the RRC signaling for indicating that the information related to REP is indicated through the DCI, and the information related to REP is received through the DCI if there is first information in the RRC signaling for indicating that the information related to REP is indicated through the DCI.

Specifically, if there is no repetitionNumber-r17 (i.e., first information) in maxNrofDL-Allocations configured via the RRC signaling, then the REP of PDSCH is indicated through the first or second MAC CE defined in the disclosure, wherein, maxNrofDL-Allocations and repetitionNumber-r17 have been defined in the 3GPP protocol, as shown in Table 2 above, and will not be described here. In this case, before the NTN UE receives a MAC CE of the above type from the network node, the NTN UE may set the REP of the PDSCH to a default value, such as 1 or 4.

When the NTN UE receives the first MAC CE from the network node, a MAC entity of the NTN UE instructs its bottom layer to adopt the REP of the PDSCH indicated in this MAC CE at the time slot determined by equation 19.

$$n + 3 {N}_{slot}^{subframe , μ} n + 3 {N}_{slot}^{subframe , μ} + {K}_{offset} \qquad ( 19 )$$

wherein

$${N}_{slot}^{subframe , μ}$$

denotes the number of time slots contained in each subframe, for a system with a subcarrier interval μ; K_{offset} denotes a cell-level parameter, which may be configured by the RRC signaling; n denotes the current time slot n.

When the NTN UE receives the second MAC CE from the network node, the MAC entity of the NTN UE instructs its bottom layer to adopt the REP of the PDSCH indicated in this MAC CE starting from the time slot determined through equation 19 above. For example, when the second MAC CE indicates REPs for total four time slots, the four REPs for the four time slots indicated by the four fields in this MAC CE may be used sequentially, at the four time slots starting from the time slot determined by equation 19 above.

In another exemplary embodiment of the disclosure, if there is repetitionNumber-r17 (i.e., first information) in the maxNrofDL-Allocations configured through the RRC signaling, the NTN UE may determine the REP of PDSCH by parsing a Time domain resource assignment field in the DCI before receiving the aforementioned type of MAC CE from the network node.

When the NTN UE receives the first MAC CE from the network node, the MAC entity of the NTN UE instructs its bottom layer to adopt the REP of the PDSCH indicated in this MAC CE in the time slot determined through equation 19 above. When the NTN receives the second MAC CE from the network node, the MAC entity of the NTN UE instructs its bottom layer to adopt the REPs of the PDSCH indicated in this MAC CE starting from the time slot determined through the above equation 19.

The disclosure indicates the REP (i.e., the repetition number) of the PDSCH through the two types of MAC CE defined above and the corresponding MAC sub headers, which may reduce the signaling overhead.

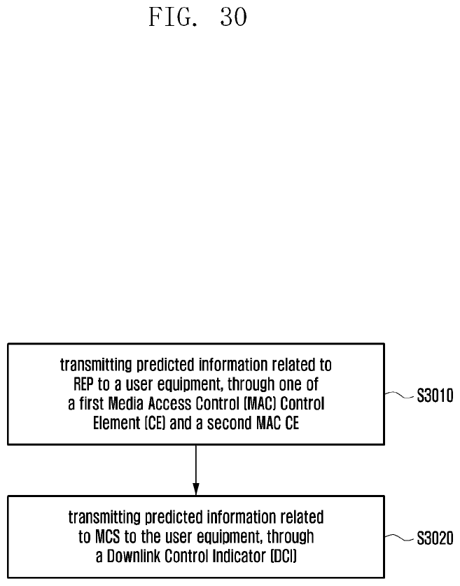

FIG. 30 shows a method performed by a network node according to another exemplary embodiment of the disclosure. In step S3010, predicted information related to REP is transmitted to a user equipment through one of a first media access control (MAC) control element (CE) and a second MAC CE. In Step S3020, predicted information related to MCS is transmitted to the user equipment, through a downlink control indicator (DCI). Wherein, the predicted information related to REP is transmitted to the user equipment through one of the first media access control (MAC) control element (CE) and the second MAC CE; and the predicted information related to MCS is transmitted to the user equipment, through the downlink control indicator (DCI). The first MAC CE and the second MAC CE are identified using a logical channel identifier (LCID) in a MAC sub header. The first MAC CE includes one field for indicating the REP of the PDSCH for one time slot, a length of the second MAC CE is indicated by a length field in the corresponding MAC sub header, and the second MAC CE includes a plurality of fields for indicating the REP for each of the plurality of time slots, respectively. Since it has been described above in detail with reference to the relevant contents in drawings, it will not be further repeated here.

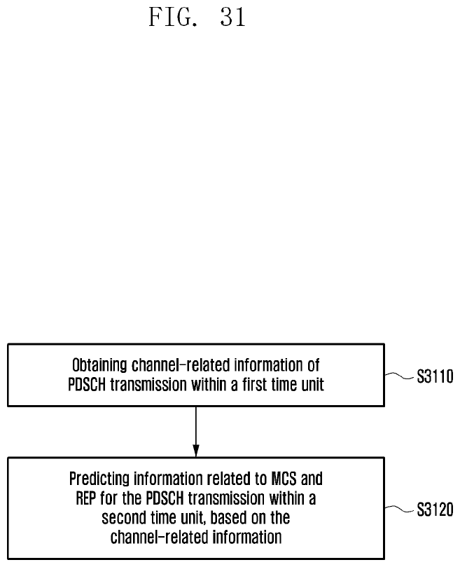

FIG. 31 shows a method performed by a network node according to another exemplary embodiment of the disclosure.

As shown in FIG. 31, in step S3110, channel-related information of PDSCH transmission within a first time unit is obtained. In step S3120, information related to MCS and REP for the PDSCH transmission within a second time unit is predicted, through the AI network, based on the channel-related information. In step S3130, the predicted information related to MCS and REP is transmitted to the user equipment. Wherein, the channel related information includes at least one of CQI information, BLER information, SINR information, MCS information, and REP information. The BLER information is obtained based on HARQ ACK/NACK information for the PDSCH transmission, and at least part of the HARQ ACK/NACK information for the PDSCH transmission is obtained based on a RLC status PDU. Step S3110 and S3120 are the same as the operations performed in steps S1510 and S1520 of FIG. 15, respectively, therefore, they will not be repeated here.

A network node is also provided in an embodiment of the disclosure, which may include a transceiver for transmitting and receiving a signal; and a processor coupled to the transceiver and configured to perform the method performed by the network node as described above.

A UE is also provided in an embodiment of the disclosure, which may include: a transceiver for transmitting and receiving a signal; and a processor coupled to the transceiver and configured to perform the method performed by the UE as described above.

A computer readable storage medium storing instructions is also provided in an embodiment of the disclosure, the instructions, when being executed by at least one processor, cause the at least one processor to perform the method performed by the network node or by the UE as described above.

A computer program product including computer programs is also provided in an embodiment of the disclosure, the computer programs, when being executed by a processor, may implement the steps and corresponding content of the aforementioned method embodiments.

The terms “first,” “second,” “third,” “fourth,” “1,” “2” and the like (if exists) in the specification and claims of the disclosure and the above drawings are used to distinguish similar objects, and need not be used to describe a specific order or sequence. It should be understood that terms used as such may be interchanged in appropriate situations, so that the embodiments of the disclosure described here may be implemented in an order other than the illustration or text description.

It should be understood that, although each operation step is indicated by an arrow in the flowcharts of the embodiments of the disclosure, an implementation order of these steps is not limited to an order indicated by the arrows. Unless explicitly stated herein, in some implementation scenarios of the embodiments of the disclosure, the implementation steps in the flowcharts may be executed in other orders according to requirements. In addition, some or all of the steps in each flowchart may include a plurality of sub steps or stages, based on an actual implementation scenario. Some or all of these sub steps or stages may be executed at the same time, and each sub step or stage in these sub steps or stages may also be executed at different times. In scenarios with different execution times, an execution order of these sub steps or stages may be flexibly configured according to a requirement, which is not limited by the embodiment of the disclosure.

The above text and accompanying drawings are provided as examples only to assist readers in understanding the disclosure. They are not intended and should not be interpreted as limiting the scope of the disclosure in any way. Although certain embodiments and examples have been provided, based on the content disclosed herein, it is apparent to those skilled in the art that, changes can be made to the illustrated embodiments and examples without departing from the scope of the disclosure, and other similar implementation methods based on the technical concepts of the disclosure also belongs to a protection scope of the embodiments of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station of a non-terrestrial network (NTN) in a wireless communication system, the method comprising:
transmitting, to a terminal, a first physical downlink shared channel (PDSCH) in first slots, wherein the first slots include at least one slot where the first PDSCH is scheduled without hybrid automatic repeat request (HARQ) feedback;
receiving, from the terminal, channel quality information and feedback information, wherein the feedback information includes HARQ feedback information and radio link control (RLC) status information associated with a transmission of the first PDSCH in the at least one slot;
predicting a modulation and coding scheme (MCS) and a repetition number for a second PDSCH based on information associated with the channel quality information and the feedback information;
transmitting, to the terminal, information on the MCS and information on the repetition number; and
transmitting, to the terminal, the second PDSCH in second slots based on the MCS and the repetition number.

2. The method of claim 1, wherein the MCS and the repetition number are predicted based on block error rate (BLER) information, and
wherein the BLER information is generated based on an acknowledge/negative acknowledge (ACK/NACK) value associated with the HARQ feedback and an ACK/NACK value associated with the RLC status information.

3. The method of claim 2, wherein the ACK/NACK value associated with the HARQ feedback is determined based on a number of transmissions of the first PDSCH scheduled with the HARQ feedback, and
wherein a determination of the ACK/NACK value associated with the HARQ feedback includes:
in case that the number is equal to one, determining the ACK/NACK value associated with the HARQ feedback as a value that corresponds to the received HARQ feedback information;
in case that the number is greater than one and the received HARQ feedback information corresponds to a NACK, determining the ACK/NACK value associated with the HARQ feedback as the NACK; and
in case that the number is greater than one and the received HARQ feedback information corresponds to an ACK, determining the ACK/NACK value associated with the HARQ feedback based on a probability that HARQ feedback corresponding to a first transmission of the first PDSCH is a NACK.

4. The method of claim 2, wherein the ACK/NACK value associated with the RLC status information is determined based on a correspondence relationship between a sequence number (SN) included in the RLC status information and a slot associated with the RLC status information,
wherein the RLC status information further includes information on an ACK/NACK value corresponding to the SN, and
wherein the correspondence relationship is generated based on RLC data information and scheduling information associated with the transmission of the first PDSCH.

5. The method of claim 1, wherein signal to interference plus noise ratio (SINR) information is used for a prediction of the MCS and the repetition number,
wherein the SINR information is generated based on the received channel quality information and information on a path loss between the base station and the terminal,
wherein the path loss is determined based on weather information and ephemeris information of a satellite associated with the base station.

6. The method of claim 1, wherein the MCS and the repetition number are predicted based on a large scale channel feature and a small scale channel feature,
wherein the large scale channel feature and the small scale channel feature are generated based on the received channel quality information and the feedback information,
wherein the large scale channel feature is further generated based on an MCS and a repetition number for a third PDSCH transmitted before a transmission of the first PDSCH, and
wherein the small scale channel feature is generated based on a long short-term memory (LSTM) neural network without an outer loop rate control (OLRC) input gate.

7. The method of claim 1, wherein the information on the MCS is transmitted to the terminal via downlink control information (DCI),
wherein the information on the repetition number is transmitted via the DCI or a medium access control (MAC) control element (CE) based on a determination whether a radio resource control (RRC) configuration for the terminal includes indication information on the repetition number, and
wherein the MAC CE includes a first MAC CE indicating that the repetition number is related to a slot or a second MAC CE indicating that the repetition number is related to a plurality of slots.

8. A method performed by a terminal in a wireless communication system, the method comprising:
receiving, from a base station of a non-terrestrial network (NTN), a first physical downlink shared channel (PDSCH) in first slots, wherein the first slots include at least one slot where the first PDSCH is scheduled without a hybrid automatic repeat request (HARQ) feedback;
generating channel quality information, HARQ feedback information, and radio link control (RLC) status information associated with a reception of the first PDSCH in the at least one slot, based on the reception of the first PDSCH;
transmitting, to the base station, the channel quality information and feedback information including the HARQ feedback information and the RLC status information;
receiving, from the base station, information on a modulation and coding scheme (MCS) for a second PDSCH and information on a repetition number for the second PDSCH; and
receiving, from the base station, the second PDSCH in second slots based on the MCS and the received repetition number.

9. The method of claim 8, wherein the information on the MCS is received from the base station via downlink control information (DCI),
wherein the information on the repetition number is received from the base station via the DCI or a medium access control (MAC) control element (CE), based on whether a radio resource control (RRC) configuration for the terminal includes indication information on the repetition number, and
wherein the MAC CE includes a first MAC CE indicating that the repetition number is related to a slot or a second MAC CE indicating that the repetition number is related to a plurality of slots.

10. A base station of a non-terrestrial network (NTN) in a wireless communication system, the base station comprising:
a transceiver;
memory storing one or more programs; and
one or more processors communicatively coupled to the transceiver and the memory,
wherein the one or more programs include computer-executable instructions that, when executed by the one or more processors individually or collectively, cause the base station to:
transmit, to a terminal, a first physical downlink shared channel (PDSCH) in first slots, wherein the first slots include at least one slot where the first PDSCH is scheduled without hybrid automatic repeat request (HARQ) feedback,
receive, from the terminal, channel quality information and feedback information, wherein the feedback information includes HARQ feedback information and radio link control (RLC) status information associated with a transmission of the first PDSCH in the at least one slot,
predict a modulation and coding scheme (MCS) and a repetition number for a second PDSCH, based on information associated with the channel quality information and the feedback information,
transmit, to the terminal, information on the MCS and information on the repetition number, and
transmit, to the terminal, the second PDSCH in second slots based on the MCS and the repetition number.

11. The base station of claim 10, wherein the MCS and the repetition number are predicted based on block error rate (BLER) information,
wherein the BLER information is generated based on an acknowledge/negative acknowledge (ACK/NACK) value associated with the HARQ feedback and an ACK/NACK value associated with the RLC status information,
wherein the ACK/NACK value associated with the HARQ feedback is determined based on a number of transmissions of the first PDSCH scheduled with the HARQ feedback,
wherein a determination of the ACK/NACK value associated with the HARQ feedback includes:
in case that the number is equal to one, determining the ACK/NACK value associated with the HARQ feedback as a value that corresponds to the received HARQ feedback information;
in case that the number is greater than one and the received HARQ feedback information corresponds to a NACK, determining the ACK/NACK value associated with the HARQ feedback as the NACK; and
in case that the number is greater than one and the received HARQ feedback information corresponds to an ACK, determining the ACK/NACK value associated with the HARQ feedback based on a probability that HARQ feedback corresponding to a first transmission of the first PDSCH is a NACK,
wherein the ACK/NACK value associated with the RLC status information is determined based on a correspondence relationship between a sequence number (SN) included in the RLC status information and a slot associated with the RLC status information,
wherein the RLC status information further includes information on an ACK/NACK value corresponding to the SN, and
wherein the correspondence relationship is generated based on RLC data information and scheduling information associated with the transmission of the first PDSCH.

12. The base station of claim 10, wherein signal to interference plus noise ratio (SINR) information is used for a prediction of the MCS and the repetition number,
wherein the SINR information is generated based on the received channel quality information and information on a path loss between the base station and the terminal,
wherein the path loss is determined based on weather information and ephemeris information of a satellite associated with the base station,
wherein the MCS and the repetition number are predicted based on a large scale channel feature and a small scale channel feature,
wherein the large scale channel feature and the small scale channel feature are generated based on the received channel quality information and the feedback information,
wherein the large scale channel feature is further generated based on an MCS and a repetition number for a third PDSCH transmitted before a transmission of the first PDSCH, and
wherein the small scale channel feature is generated by based on a long short-term memory (LSTM) neural network without an outer loop rate control (OLRC) input gate.

13. The base station of claim 10, wherein the information on the MCS is transmitted to the terminal via downlink control information (DCI),
wherein the information on the repetition number is transmitted via the DCI or a medium access control (MAC) control element (CE) based on a determination whether a radio resource control (RRC) configuration for the terminal includes indication information on the repetition number, and
wherein the MAC CE includes a first MAC CE indicating that the repetition number is related to a slot or a second MAC CE indicating that the repetition number is related to a plurality of slots.

14. A terminal in a wireless communication system, the terminal comprising:
a transceiver;
memory storing one or more programs; and
one or more processors communicatively coupled to the transceiver and the memory,
wherein the one or more programs include computer-executable instructions that, when executed by the one or more processors individually or collectively, cause the terminal to:
receive, from a base station of a non-terrestrial network (NTN), a first physical downlink shared channel (PDSCH) in first slots, wherein the first slots include at least one slot where the first PDSCH is scheduled without a hybrid automatic repeat request (HARQ) feedback,
generate channel quality information, HARQ feedback information, and radio link control (RLC) status information associated with a reception of the first PDSCH in the at least one slot, based on the reception of the first PDSCH,
transmit, to the base station, the channel quality information and feedback information including the HARQ feedback information and the RLC status information,
receive, from the base station, information on a modulation and coding scheme (MCS) for a second PDSCH and information on a repetition number for the second PDSCH, and
receive, from the base station, the second PDSCH in second slots based on the MCS and the repetition number.

15. The terminal of claim 14, wherein the information on the MCS is received from the base station via downlink control information (DCI),
wherein the information on the repetition number is received from the base station via the DCI or a medium access control (MAC) control element (CE), based on whether a radio resource control (RRC) configuration for the terminal includes indication information on the repetition number, and
wherein the MAC CE includes a first MAC CE indicating that the repetition number is related to a slot or a second MAC CE indicating that the repetition number is related to a plurality of slots.
